(19) United States
(12) Patent Application Publication
(10) Pub. No.: US 2026/0113417 A1
(43) Pub. Date: Apr. 23, 2026

(54) SYSTEM FOR SMART WIDE AREA ENVIRONMENTAL VEHICLE MONITORING AND TARGETED MONITORING ASSISTANCE

(71) Applicant: Volvo Car Corporation, Göteborg (SE)

(72) Inventors: Daniel Young, Göteborg (SE); Derek Boesch, Göteborg (SE); Andrew Fiorino, Göteborg (SE); William Figueroa, Göteborg (SE); Giovanni Spiritoso, Göteborg (SE); Josh Crim, Göteborg (SE); Brian Burgard, Göteborg (SE); Peter Barcia, Göteborg (SE)

(21) Appl. No.: 18/924,116

(22) Filed: Oct. 23, 2024

(51) Int. Cl. H04N 7/18; G06V 20/52; G06V 20/56

(52) U.S. Cl. CPC H04N 7/181; G06V 20/52; G06V 20/56

(57) ABSTRACT

A system for targeted vehicle monitoring assistance includes one more external cameras supported relative to a vehicle. The system is configured to determine a position of a suspicious area relative to the vehicle. The suspicious area is associated with a suspicious event in the vicinity of a stowed vehicle and within a wide area environment of the vehicle. The system is further configured to communicate data from the at least one external camera suitable to provide a supplemental view of the suspicious area.

### TECHNICAL FIELD

The present disclosure relates generally to the automotive field. More particularly, the present disclosure relates to active local and remote monitoring for a stowed vehicle and facilitating communication between the stowed vehicle and a mobile device of a remote operator.

### BACKGROUND

After operation of a vehicle, the vehicle is typically parked without any occupants until an operator or owner of the vehicle decides to use the vehicle again, e.g., a stowed vehicle. However, events often happen around a stowed vehicle in which an operator or owner would investigate or take action if the operator/owner were in the vehicle or in close proximity of the vehicle. For example, an operator/owner that is present may prevent or deter vandalism of the vehicle or investigate alarms, dubious sounds, and the like in close proximity of the vehicle. A present operator/owner may also recognize that a pedestrian around the vehicle requires medical attention. For example, the operator/owner may act as a good Samaritan and call emergency services if a person passes out. Unfortunately, an absent operator/owner of the stowed vehicle is unable to monitor for any of these suspicious events.

In the case of vandalism, a hit and run, or the like on the stowed vehicle without a present owner/operator/occupant, it may be difficult to establish what happened, and there may be disagreement over who was at fault. Parties involved in the suspicious event may even leave the scene, making it difficult to identify the other vehicle(s), pedestrian(s), etc. involved in the suspicious event. Thus, an owner/operator investigating the suspicious event may have to collect information from unreliable witnesses well after the fact, if there are any that can be identified. The result may be an inadequate determination of circumstances and fault.

A variety of dash-cams and the like are available that may automatically capture an image/video of a suspicious event, but all desired angles are not typically covered, and the suspicious event itself may render such dash-cams and the like inoperable. Thus, these dash-cams and the like may not adequately assist in identifying the other vehicles, pedestrians, etc. involved in the suspicious event. Even if the suspicious event is captured by such a dash-cam, simply recording the suspicious event does nothing to prevent the suspicious event or facilitate immediate action by the owner/operator.

Similarly, many vehicles include alarm systems that activate based upon impacts on the vehicle and/or physical tampering with systems of the vehicle, such as the locks. While such alarm systems may deter or prevent certain acts of vandalism or theft, traditional vehicle alarms are not suitable to detect and respond to various other suspicious events. Criminals often have experience avoiding activating such vehicle alarms. The owner/operator may also be too far away to hear such an alarm and investigate or may not recognize that an alarm is coming from his/her vehicle. In such cases, active monitoring of the stowed vehicle and/or contemporaneous evidence gathering by the vehicle itself would be helpful. As such, a need exists in the art for a system and associated methods and control systems for vehicles that overcome the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide a system for active monitoring of a stowed vehicle and associated methods of operation and control systems that overcome the limitations of the known art.

Embodiments of the disclosed systems and methods facilitate communication between a stowed vehicle and a remote device (e.g., mobile device) of an operator/owner of the stowed vehicle. Generally, the owner/operator may be outside of the surroundings or immediate surroundings of the stowed vehicle. The system (via, e.g., an associated suspicious event identification module and/or associated method elements) can determine an occurrence of a suspicious event in the vicinity of the stowed vehicle based on a reduced volume of external environmental data processed while the vehicle is stowed. Once the suspicious event has been identified, a suspicious area around the suspicious event may be determined relative to the stowed vehicle or its external sensors. Thereafter, a larger volume of external environmental data indicating the determined suspicious area may be monitored by the system. Sensors and/or data indicating other areas of the vicinity of the stowed vehicle may not be utilized or processed to conserve resources. For example, external sensors kept off or in standby before detection of the suspicious event may be powered, and/or data communicated from such sensors may be processed by the system after determining the suspicious event and that such sensor indicates the suspicious event or suspicious area. Thus, battery power of the system may be conserved by only monitoring the suspicious area associated with a suspicious event in detail and otherwise monitoring or processing the reduced volume of data for the occurrence of the suspicious event.

The initial determination of the suspicious event may also be based on the location of the stowed vehicle and crime data for such location, a schedule of the vehicle or the operator/owner, and/or a travel history of the same. The system may further identify a potential suspicious event utilizing the reduced volume of data and confirm the existence of the suspicious event utilizing the larger volume of data. If required, the system may process or monitor even more data or different data if the larger volume of data does not adequately represent the confirmed suspicious event or the surrounding suspicious area. Thus, the system monitors more data for a determined suspicious event and utilizes the most appropriate external sensors to monitor the suspicious event and suspicious area as circumstances change, such as movement of involved individuals, objects, vehicles, and the like.

The present disclosure also contemplates situations where the local external sensors of the stowed vehicle do not adequately represent the suspicious event and associated area. To ensure that suspicious events are recognized and associated areas determined, systems disclosed herein contemporaneously request and/or receive related information from the vehicle itself, from any surrounding devices, including vehicles, and/or from infrastructure devices that may have captured the vehicle incident. The vehicle opens a communication link with the other vehicle(s) and/or from the surrounding devices, including the vehicles and/or the infrastructure devices. Images/videos are requested with a specific timeframe (e.g., 22 seconds before and 1 minute after the vehicle incident). Various other information may also be exchanged over the bidirectional communication link (e.g., system identifiers, witness names and contact information, etc.).

The system (via, e.g., an associated communication module and/or associated method elements) may communicate an alert to the mobile device of the operator/owner of stowed vehicle. The alert may indicate the type of suspicious event and/or the position of the suspicious area relative to the stowed vehicle. The alert may also include an audio recording, a captured image, and/or a video recording of the suspicious event, the suspicious area, the vicinity surroundings of the stowed vehicle, and/or a wide area surrounding the stowed vehicle. In some embodiments, the system may receive a selection from the mobile device requesting continuous monitoring, and the system may communicate a continuous audio feed, video feed, or both of the suspicious event and/or suspicious area utilizing the sensors best situated and oriented to indicate the same. In other embodiments, the alert may already include one or more of the continuous audio feed or video feed.

The mobile device may also provide instructions to the system in response to the received alert. For example, the owner/operator may indicate via the mobile device that a prerecorded message should be produced via one or more external speakers, such as the external speaker(s) closest to external cameras best situation to capture the suspicious event or suspicious area. For example, the prerecorded message may be “Get away from the vehicle. You are being tape recorded,” “police are on their way,” or the like. Alternatively, the mobile device may communicate a continuous audio feed from a microphone(s) of the mobile device for production by external speakers of the stowed vehicle, allowing the owner/operator to communicate in real time with people in the vicinity of the stowed vehicle.

To achieve the foregoing and other objects and advantages, in one aspect, the present subject matter is directed to a system for targeted vehicle monitoring assistance including one more external cameras supported relative to a vehicle and at least one memory storing instructions that, when executed by one or more processors, cause the one or more processors to determine a position of a suspicious area relative to the vehicle. The suspicious area is associated with a suspicious event in the vicinity of a stowed vehicle and within a wide area environment of the vehicle. The instructions further cause the processor(s) to communicate data from the at least one external camera suitable to provide a supplemental view of the suspicious area.

In at least one embodiment, the instructions may further cause the processor(s) to determine, based on a request for supplemental monitoring, the occurrence of the suspicious event in the vicinity of the stowed vehicle. Additionally or alternatively, the instructions may further cause the processor(s) to process only a first volume of data communicated from a first external camera of the at least one external camera prior to identification of the suspicious event in the vicinity of the stowed vehicle. Additionally or alternatively, the first external camera may be at least one of a wide area camera or a bird's-eye-view camara. Additionally or alternatively, the instructions may further cause the processor(s) to determine, based on the processed first volume of data, the occurrence of the suspicious event in the vicinity of the stowed vehicle.

In additional or alternative embodiments, the instructions may further cause the processor(s) to process, in response to the determination of the suspicious event, a second volume of data communicated from the at least one external camera. The second volume of data may be greater than the first volume of data and may include the data suitable to provide the supplemental view. Additionally or alternatively, the instructions may further cause the processor(s) to qualitatively assess the value of the supplemental view for monitoring the suspicious area. Additionally or alternatively, the instructions may further cause the processor(s) to communicate data from the at least one external camera suitable to provide a view of a predicted escape route of at least one suspicious vehicle or individual associated with the suspicious event.

In an additional or alternative aspect, the present subject matter is directed to a non-transitory computer-readable medium comprising instructions stored in at least one memory that, when executed by one or more processors, cause the one or more processors to carry out steps. The steps include receiving a request for supplemental monitoring of a suspicious area associated with a suspicious event in a vicinity of the stowed vehicle and within a wide area environment of the vehicle. The steps further include communicating an indication of a detection area of an external camera supported relative to the vehicle. The communicated indication is targeted to the stowed vehicle. The steps additionally include communicating supplemental monitoring data from the vehicle and targeted to the stowed vehicle. The supplemental monitoring data is suitable to provide a supplemental view of the suspicious area.

In at least one embodiment, the supplemental monitoring data may be suitable to provide at least one of a supplemental recording or continuous video feed of the suspicious area. Additionally or alternatively, the steps may include communicating a supplemental alert indicating an occurrence of the suspicious event within the wide area environment of the vehicle. Additionally or alternatively, the steps may include communicating at least one of location information associated with vehicle, location information associated with the suspicious area, identification information associated with the vehicle, or identification information associated with the suspicious event. In some such embodiments or different embodiments, the request for supplemental monitoring may indicate at least one of location information associated with stowed vehicle, location information associated with the suspicious area, identification information associated with the stowed vehicle, or identification information associated with the suspicious event.

Additionally or alternatively, the steps may include communicating a qualitive value assessment generated at the vehicle and indicating a value of the remote camera for monitoring the suspicious area. Additionally or alternatively, the steps may include receiving a graphical representation of a relative position of the suspicious area and the stowed vehicle. Additionally or alternatively, the steps may include communicating a graphical representation of a relative position of the suspicious area and at least one detection area of at least one external camera of the vehicle. Additionally or alternatively, the steps may include receiving an indication of a predicted escape route of at least one suspicious vehicle or individual associated with the suspicious event. Additionally or alternatively, the steps may include communicating an indication of a predicted escape route generated at the vehicle of at least one suspicious vehicle or individual associated with the suspicious event. Additionally or alternatively, the steps may include communicating escape monitoring data from the vehicle and targeted to the stowed vehicle. The escape monitoring data may be suitable to provide a view of a predicted escape route of at least one suspicious vehicle or individual associated with the suspicious event. Additionally or alternatively, the steps may include communicating modified location information associated with the suspicious area and generated at the vehicle.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the companying drawings, in which:

FIG. 1 illustrates a schematic diagram of an exemplary embodiment of a system for active monitoring of a stowed vehicle, in accordance with aspects of the present subject matter;

FIG. 2 illustrates a schematic diagram of an exemplary embodiment of a vehicle including or suitable for use with a system for active monitoring of a stowed vehicle, in accordance with aspects of the present subject matter;

FIG. 3 illustrates a schematic logic diagram of an exemplary embodiment of a system for active monitoring of a stowed vehicle, in accordance with aspects of the present subject matter;

FIG. 4A illustrates an exemplary embodiment of a method including method elements, one or more of which may be implemented in a method for active monitoring of a stowed vehicle, in accordance with aspects of the present subject matter;

FIG. 4B illustrates an exemplary embodiment of a method including additional or alternative method elements, one or more of which may be implemented in a method for active monitoring of a stowed vehicle, in accordance with aspects of the present subject matter;

FIG. 4C illustrates an exemplary embodiment of a method including additional or alternative method elements, one or more of which may be implemented in a method for active monitoring of a stowed vehicle, in accordance with aspects of the present subject matter;

FIG. 4D illustrates an exemplary embodiment of a method including additional or alternative method elements, one or more of which may be implemented in a method for active monitoring of a stowed vehicle, in accordance with aspects of the present subject matter;

FIG. 4E illustrates an exemplary embodiment of a method including additional or alternative method elements, one or more of which may be implemented in a method for active monitoring of a stowed vehicle, in accordance with aspects of the present subject matter;

FIG. 4F illustrates an exemplary embodiment of a method including additional or alternative method elements, one or more of which may be implemented in a method for active monitoring of a stowed vehicle, in accordance with aspects of the present subject matter;

FIG. 4G illustrates an exemplary embodiment of a method including additional or alternative method elements, one or more of which may be implemented in a method for active monitoring of a stowed vehicle, in accordance with aspects of the present subject matter;

FIG. 5A illustrates a schematic diagram of an exemplary embodiment of a graphical representation indicating a relative position of a suspicious area associated with a suspicious event and a stowed vehicle, in accordance with aspects of the present subject matter;

FIG. 5B illustrates a schematic diagram of an exemplary embodiment of a graphical representation indicating a relative position between remote cameras and detection areas thereof and a suspicious area associated with a suspicious event in a vicinity of a stowed vehicle, in accordance with aspects of the present subject matter;

FIG. 5C illustrates a schematic diagram of an exemplary embodiment of a graphical representation indicating a predicted escape route of a suspicious vehicle and/or individual associated with a suspicious event, in accordance with aspects of the present subject matter;

FIG. 6 illustrates a schematic diagram of an exemplary embodiment of a communication protocol that may be utilized in conjunction with the systems and methods disclosed herein, in accordance with aspects of the present subject matter;

FIG. 7 illustrates a schematic diagram of an exemplary embodiment of a network of a cloud-based system for implementing various cloud-based services, in accordance with aspects of the present subject matter;

FIG. 8 illustrates a schematic diagram of an exemplary embodiment of a server which may be used in the cloud-based system of FIG. 7 or stand-alone, in accordance with aspects of the present subject matter; and

FIG. 9 illustrates a schematic diagram of an exemplary embodiment of a user device which may be used in the cloud-based system of FIG. 7 or stand-alone, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, embodiments of the disclosed systems and methods facilitate communication between a stowed vehicle and a remote device (e.g., mobile device) of an operator/owner of the stowed vehicle. Generally, the owner/operator may be outside of the surroundings or immediate surroundings of the stowed vehicle. The system (via, e.g., an associated suspicious event identification module and/or associated method elements) can determine an occurrence of a suspicious event in the vicinity of the stowed vehicle based on a reduced volume of external environmental data processed while the vehicle is stowed. Once the suspicious event has been identified, a suspicious area around the suspicious event may be determined relative to the stowed vehicle or its external sensors. Thereafter, a larger volume of external environmental data indicating the determined suspicious area may be monitored by the system. Sensors and/or data indicating other areas of the vicinity of the stowed vehicle may not be utilized or processed to conserve resources. For example, external sensors kept off or in standby before detection of the suspicious event may be powered, and/or data communicated from such sensors may be processed by the system after determining the suspicious event and that such sensor indicates the suspicious event or suspicious area. Thus, battery power of the system may be conserved by only monitoring the suspicious area associated with a suspicious event in detail and otherwise monitoring or processing the reduced volume of data for the occurrence of the suspicious event.

The initial determination of the suspicious event may also be based on the location of the stowed vehicle and crime data for such location, a schedule of the vehicle or the operator/owner, and/or a travel history of the same. The system may further identify a potential suspicious event utilizing the reduced volume of data and confirm the existence of the suspicious event utilizing the larger volume of data. If required, the system may process or monitor even more data or different data if the larger volume of data does not adequately represent the confirmed suspicious event or the surrounding suspicious area. Thus, the system monitors more data for a determined suspicious event and utilizes the most appropriate external sensors to monitor the suspicious event and suspicious area as circumstances change, such as movement of involved individuals, objects, vehicles, and the like.

The present disclosure also contemplates situations where the local external sensors of the stowed vehicle do not adequately represent the suspicious event and associated area. To ensure that suspicious events are recognized and associated areas determined, systems disclosed herein contemporaneously request and/or receive related information from the vehicle itself, from any surrounding devices, including vehicles, and/or from infrastructure devices that may have captured the vehicle incident. The vehicle opens a communication link with the other vehicle(s) and/or from the surrounding devices, including the vehicles and/or the infrastructure devices. Images/videos are requested with a specific timeframe (e.g., 22 seconds before and 1 minute after the vehicle incident). Various other information may also be exchanged over the bidirectional communication link (e.g., system identifiers, witness names and contact information, etc.).

The system (via, e.g., an associated communication module and/or associated method elements) may communicate an alert to the mobile device of the operator/owner of stowed vehicle. The alert may indicate the type of suspicious event and/or the position of the suspicious area relative to the stowed vehicle. The alert may also include an audio recording, a captured image, and/or a video recording of the suspicious event, the suspicious area, the vicinity surroundings of the stowed vehicle, and/or a wide area surrounding the stowed vehicle. In some embodiments, the system may receive a selection from the mobile device requesting continuous monitoring, and the system may communicate a continuous audio feed, video feed, or both of the suspicious event and/or suspicious area utilizing the sensors best situated and oriented to indicate the same. In other embodiments, the alert may already include one or more of the continuous audio feed or video feed.

The mobile device may also provide instructions to the system in response to the received alert. For example, the owner/operator may indicate via the mobile device that a prerecorded message should be produced via one or more external speakers, such as the external speaker(s) closest to external cameras best situation to capture the suspicious event or suspicious area. For example, the prerecorded message may be “Get away from the vehicle. You are being tape recorded,” “police are on their way,” or the like. Alternatively, the mobile device may communicate a continuous audio feed from a microphone(s) of the mobile device for production by external speakers of the stowed vehicle, allowing the owner/operator to communicate in real time with people in the vicinity of the stowed vehicle.

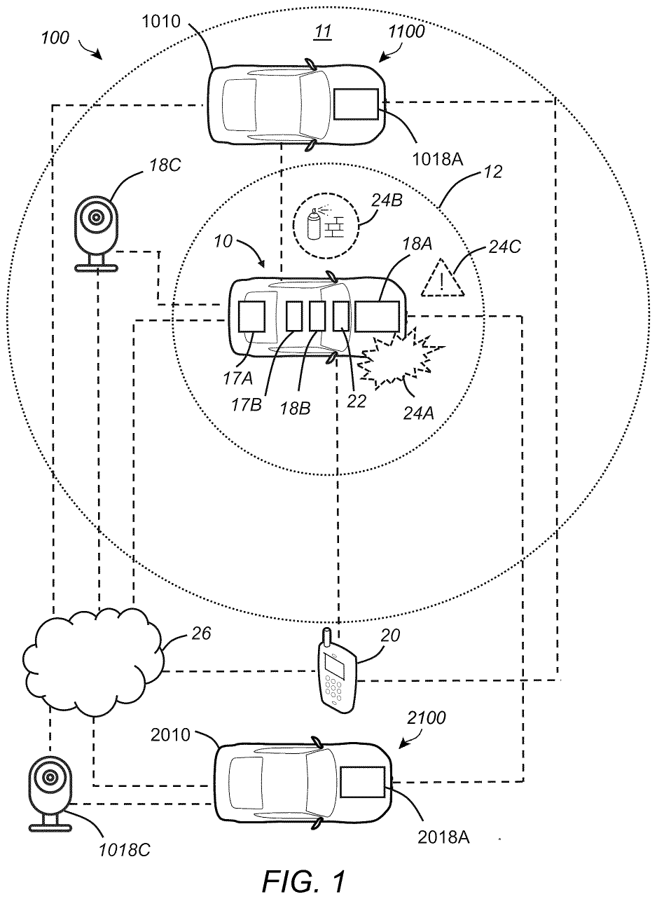

Referring now generally to FIG. 1, a schematic diagram of an exemplary embodiment of a system for active monitoring of a stowed vehicle is illustrated in accordance with aspects of the present subject matter. As shown, a vehicle 10 may generally include a system 100 for controlling and/or managing the operation of one or more components of the vehicle 10 utilized to or in association with active monitoring of a stowed vehicle 10 (e.g., parked, unoccupied vehicle, and/or stored vehicle) for suspicious or potentially suspicious events such as vandalism, theft, hit and runs, medical emergencies, and the like. Particularly, the system 100 and/or vehicle 10 may be configured to monitor a vicinity surrounding the stowed vehicle 10 (e.g., a vicinity 12 of FIG. 1).

Optionally, e.g., as required, the system 100 and/or vehicle 10 may automatically and contemporaneously request and/or receive related information from a remote camera to provide a supplemental view of a suspicious event and/or a suspicious area associated with a suspicious event in a vicinity 12 of the stowed vehicle 10, as described herein. Thus, the system 100 may be configured to supplement active monitoring of the stowed vehicle 10. In various instances, the remote camera may be configured as or included in a differently configured vehicle without a system as described herein and/or an infrastructure device (e.g., remote camera 18C and/or remote camera 1018C). Suitable infrastructure devices include, without limitation, a traffic camera, a business camera, an ATM camera, or the like.

In other instances, the remote camera may be included in another vehicle also including the system as described herein, a system for targeted vehicle monitoring assistance, and/or another system suitable to provide preprocessing of the related information and/or the supplemental view in accordance with control logic and method elements described herein (e.g., a second vehicle 1010 including a system 1100 and/or a third vehicle 2010 including a system 2100).

In some instances, the system 100 may control or manage operation of the component(s) thereof or the vehicle 10 in response to instructions/inputs received from a remote operator and/or owner (associated with a mobile device 20) of the vehicle 10, as will be explained in more detail in the following description. The mobile device 20 may include a cellular phone, smart phone, etc. of an operator/owner of the stowed vehicle 10 outside of a wide area 11 surrounding the stowed vehicle 10. The mobile device 20 may be able to communicate with the stowed vehicle 10 either directly via wireless or near-field communication links when requested by the stowed vehicle 10, or through a cloud network 26 to which all the components may be coupled via wireless, near-field, or wired communication links. The system 100 and/or vehicle 10 may be configured to operate with a suitably configured mobile device 20 including a camera, microphone, and other data collection sensors and devices.

The stowed vehicle 10 may be able to communicate with one or more remote cameras (e.g., 18C, 1018A, 1018C, and/or 2018A) and/or the infrastructure device(s), differently configured vehicle(s), or similarly configured vehicle (e.g., 1010 and/or 2010) including compatible, the same, or similar systems (e.g., 1100 and/or 2100) either directly via wireless or near-field communication links or through a cloud network 26. Communication between the stowed vehicle 10 and remote camera(s) and associated device(s) may be initiated by the stowed vehicle 10. However, vehicles 1010, 2010 including the same or compatible systems 1100, 2100 may initiate communication if necessary (e.g., such vehicle 1010, 2010 is the first to recognize a suspicious event involving the stowed vehicle 10). The supplemental view may generally include an image, images, a video, and/or videos requested within a specific timeframe (e.g., 22 seconds before and 1 minute after the suspicious event). Alternatively, the vehicle(s) 1010, 2010 including the same or compatible system(s) 1100, 2100 may determine the specific timeframe locally. Various other information may also be exchanged over the bidirectional communication link (e.g., system identifiers, witness names and contact information, etc.).

The wide area 11 generally represents a range around which the stowed vehicle 10 may be visually monitored. The wide area 11 at least includes the vicinity 12 surrounding the vehicle and often includes an area or large area surrounding the vicinity 12. A range of the wide area 11 from the stowed vehicle 10 may be a predetermined range such as at least 100 feet, such as at least 150 feet, such less than 300 feet. Additionally or alternatively, the wide area 11 or one or more ranges thereof may be determined based on the environmental context surrounding the stowed vehicle 10. For example, the wide area 11 may define a reduced range in one or more directions in which an object blocks or partially blocks a view of the stowed vehicle 10, especially of the operator of the stowed vehicle 10. Such range(s) of the wide area 11 may be determined utilizing one or more appropriate artificial intelligence algorithms and based on external environmental data. Generally, the wide area 11 may also be based, at least in part, on a range of one or more external vehicle sensors 18A. For instance, the wide area 11 may be limited by at least the external vehicle sensor 18A having the furthest accurate range of measurement, e.g., a predetermined accurate range or an accurate range determined based on the environmental context surrounding the stowed vehicle 10.

The vicinity 12 may be defined as a predetermined range around the stowed vehicle 10 and/or a range in which the operator desires active monitoring. This predetermined range may be defined as within ten feet of the stowed vehicle 10, such as within five feet of the stowed vehicle 10, such as within 3 feet of the stowed vehicle 10. In some instances, the predetermined range may be selectable by the operator of the vehicle 10 and/or may be adjusted via instructions received at the vehicle 10, the system 100, and/or the mobile device 20. Additionally or alternatively, the vicinity 12 and/or one or more ranges thereof may be determined based on the environmental context surrounding the stowed vehicle 10 and/or utilizing one or more appropriate artificial intelligence algorithms.

As further illustrated in FIG. 1, the vehicle 10 and/or system 100 includes one or more environmental sensors 18, such as external environmental sensor(s) 18A, internal environmental sensor(s) 18B, and/or impact sensor(s) 18 supported relative to the stowed vehicle 10. In the depicted embodiment, the system 100 and/or vehicle 10 includes one of each of the external environmental sensors 18A and the internal environmental sensors 18B. However, various configurations of vehicles include additional, fewer, or alternatively placed environmental sensors 18. Generally, the environmental sensor(s) 18 may include one or more cameras, LiDAR sensors, radar sensors, microphones, proximity sensors, impact sensors, infrared sensors, acoustic sensors, optical sensors, seat sensor(s), sensor(s) suitable to transmit and/or receive suitable electromagnetic signals/waves, and/or the like.

In some embodiments, the external environmental sensor(s) 18A may include at least one camera such as standard, fisheye, wide area, or BEV perception sensor whether front facing, rear facing, side facing, or a combination thereof. In several embodiments, the external environmental sensor(s) 18A includes an external wide area camera, such as a BEV camera. In some embodiments and as shown, the environmental sensor(s) 18 may include the internal environmental sensor(s) 18B, such as a cabin sensor.

Additionally or alternatively, the external environmental sensor(s) 18A may include one or more of a front sensor configured to capture data indicating a portion of the vicinity 12 of the stowed vehicle 10 associated with a front bumper of the stowed vehicle 10, a rear sensor configured to capture data indicating a portion of the vicinity 12 of the stowed vehicle 10 associated with a front bumper of the stowed vehicle 10, a driver-side sensor configured to capture data indicating a portion of the vicinity 12 of the stowed vehicle 10 associated with a driver side of the stowed vehicle 10, a passenger-side sensor configured to capture data indicating a portion of the vicinity of the stowed vehicle 10 associated with a passenger side of the stowed vehicle 10, a front-driver-corner sensor configured to capture data indicating a portion of the vicinity 12 of the stowed vehicle 10 associated with a front-driver corner of the stowed vehicle 10, a front-passenger-corner sensor configured to capture data indicating a portion of the vicinity 12 of the stowed vehicle 10 associated with a front-passenger corner of the stowed vehicle 10, a rear-driver-corner sensor configured to capture data indicating a portion of the vicinity 12 of the stowed vehicle 10 associated with a rear-driver corner of the stowed vehicle 10, or a rear-passenger-corner sensor configured to capture data indicating a portion of the vicinity 12 of the stowed vehicle 10 associated with a rear-passenger corner of the stowed vehicle 10. For example, the vehicle 10 and/or system 100 may include a camera at one or multiple of these locations. Similarly, the vehicle 10 and/or system 100 may additionally or alternatively include a microphone at one or multiple of these locations.

The stowed vehicle 10 may also include a directional impact sensor and/or system (impact sensor) operable for detecting an impact on the stowed vehicle 10 and determining a direction associated with the impact. For example, the impact sensor may be operable for determining if the impact involved a front, rear, side, or a combination thereof of the stowed vehicle 10.

As depicted, the vehicle 10 and/or system 100 generally includes one more noise generators 17 supported relative to the stowed vehicle 10 and configured to produce a soundscape in an environment of the vehicle 10. The noise generator(s) 17 may generally include one or more speakers, horns, buzzers, bells, sirens, mechanical noise makers, electrical/magnetic noise makers, or the like suitable to generate sounds (e.g., an external soundscape) in an external environment surrounding the vehicle 10 and/or to generate sounds (e.g., an internal soundscape) in an internal environment (e.g., cabin, operator compartment, or the like) of the vehicle 10. Furthermore, the noise generator(s) 17 may include one or more external noise generators 17A, one or more internal noise generators 17B, or both. In the depicted embodiment, the system 100 and/or vehicle 10 includes one of each of the external noise generators 17A and internal noise generators 17B. However, various configurations of vehicles include additional, fewer, or alternatively placed noise generators 17, e.g., such as an external noise generator 17A supported or coupled to a roof of the stowed vehicle 17, e.g., an omni-directional external noise generator 17A. In various embodiments, the stowed vehicle 10 includes at least one external noise generator 17A configured as an external speaker.

Furthermore, the vehicle 10 may include hardware suitable to produce external auditory or visual signals (signaling hardware). The signaling hardware may include one or more of the external noise generators 17A (such as a horn, alarm, etc.) Additionally or alternatively, the signaling hardware may include blinkers, headlights, running lights, brake lights, high-beam lights, fog lights, and the like (omitted from FIG. 1) of the vehicle 10. As described in more detail below, signaling hardware may be utilized to identify the stowed vehicle by other vehicle(s) 1010, 2010 including the same or compatible system(s) 1100, 2100 or to identify the stowed vehicle 10 within the supplemental view provided by such vehicles 1010, 2010 and/or other remote cameras (e.g., 18c, 1018c).

It should be noted that all components may exchange data after such data is requested and the request is acknowledged and accepted. This acceptance may be given in advance or contemporaneous. For example, all components may already be subscribed to a data-sharing application that provides advance acceptance. All data exchange is performed after proper authentication and verification such that data is not exchanged with an unintended party. Such acceptance, authentication, and verification methodologies are well known to those of ordinary skill in the art and are not described in detail herein.

The vehicle 10 and/or system 100 includes one or more memory devices storing instructions that, when executed by one or more processors, cause the processor(s) to carry out one or more logical steps or method elements for active monitoring of a stowed vehicle, as described in more detail below. In some embodiments and as shown, the stowed vehicle 10 and/or system 100 may further include a control unit 22 (e.g., an electronic control unit, multiple associated control units, and/or a combination of one or more processing devices and at least one memory or memory device as described herein) communicatively coupled to one or more of the environmental sensor(s) 18, the noise generator(s) 17, one or more external device(s) 226 such a mobile device 20 of the operator/owner, and/or other components of the vehicle 10 and/or system 100, described in more detail in the following description. The control unit 22 may be configured to direct operation of one or more of such components in accordance with aspects of the present subject matter.

While a single control unit 22 is illustrated in FIG. 1 for simplicity, it should be appreciated that the control unit 22 may include multiple associated control units, electronic control units, processing devices, memory devices, or the like that together are configured to provide operational control of the stowed vehicle 10, the system 100, the noise generator(s) 17, the environmental sensor(s) 18, and/or other components of the stowed vehicle 10 and/or system 100. The control unit 22 may additionally or alternatively facilitate communication between the stowed vehicle 10, the system 100, the external device(s) 226, mobile device(s) 20, the second vehicle 1010, the remote camera 1018A of the second vehicle 1010, the third vehicle 2010, the remote camera 2018A of the third vehicle 2010, the remote camera 18C and/or associated device, the remote camera 1018C and/or associated device, additional or fewer remote cameras, the noise generator(s) 17, the environmental sensor(s) 18, the external environment of the stowed vehicle 10, the internal or cabin environment of the stowed vehicle 10, and/or internal screens, touchscreens, displays, or the like of the stowed vehicle 10 (omitted from FIG. 1). Generally, the control unit 22 may be configured to receive a signal or data indicative of the environmental context surrounding the vehicle 10 and/or the environmental context of the cabin of the vehicle 10.

In operation, the control unit 22 generally determines whether the operational status of the vehicle is stowed, e.g., parked and/or unoccupied, based on the internal environmental context and/or vehicle parameters of the vehicle 10. The control unit 22 further determines an occurrence of a suspicious event or potentially suspicious event (exemplary suspicious events 24A, 24B, 24C illustrated in FIG. 1) in the vicinity 12 of the stowed vehicle 10 based on the external environmental context of the stowed vehicle 10. In some instances, the suspicious event 24 may include an impact on the stowed vehicle 100, see suspicious impact 24A. A suspicious impact 24A may include, without limitation, an impact from a moving vehicle, an impact from a grocery cart, an impact from a vehicle door, impacts from objects (e.g., baseball bats, tire irons, etc.), or the like. Additionally or alternatively, the suspicious event 24 may include events associated with vandalism or potential vandalism, see suspicious event 24B. Suspicious events 24B may include, without limitation, an individual or group outfitted for vandalism or theft (e.g., holding or using a can of spray paint or vehicle lock-out kit) a lingering individual or group, a sudden movement, sounds of breaking glass, a sound or visual indicator associated with an alarm, and/or sounds associated with a key or hard and sharp object dragged across the body of the stowed vehicle 10 (e.g., a keyed vehicle).

Additionally or alternatively, the suspicious event 24 may include events indicating that a person or pedestrian requires or potentially requires assistance, such as medical assistance, see suspicious event 24C. Suspicious events 24C may include, without limitation, cries for help, a person requiring medical attention (e.g., suddenly falls, losses consciousness, is impacted by another vehicle, any statement indicating emergency personal should be contacted, etc.), or a mobile device 20 of an occupant of the stowed vehicle communicating signals indicating a serious and sudden medical emergency (e.g., a smart watch of an occupant communicating near-field signals to the stowed vehicle 10 indicating a sudden irregular heartbeat or other medical information associated with a potential heart attack, stroke, aneurysm, etc.). In various situations, the suspicious event 24C may involve an occupant of the stowed vehicle 10 leaving and exiting the stowed vehicle 10 or approaching the stowed vehicle 10.

In response to identifying the suspicious event 24, the control unit 22 may monitor the vicinity 12 of the stowed vehicle 10 and/or a determined portion of the vicinity 12 of the stowed vehicle 10 (e.g., a suspicious area or potentially suspicious area, respectively) with increased scrutiny. The control unit 22 may confirm the suspicious event, if required, and alert the owner/operator of the stowed vehicle 10 via the mobile device 20. The control unit 22 may further facilitate a one-way or two-way communication link (e.g., a one-way or two-way audio and/or visual call) between the vicinity 12 and the mobile device 20. The control unit 22 may automatically or selectively (e.g., in response to previous user selection or contemporaneous instruction received from the mobile device 20) cause data indicating the suspicious event 24 to be stored, especially data indicating the identified suspicious area during the suspicious event. Furthermore, the control unit 22 may include or utilize one or more artificial intelligence programs to determine the vehicle's status as stowed, the wide area 11 surrounding the stowed vehicle 10, the vicinity 12 surrounding the stowed vehicle 10, the occurrence of a suspicious event 24 or potentially suspicious event 24, and/or characteristics or parameters of the communication link between the vicinity 12 and the mobile device 20 based on the data or signals communicated to the control unit 22.

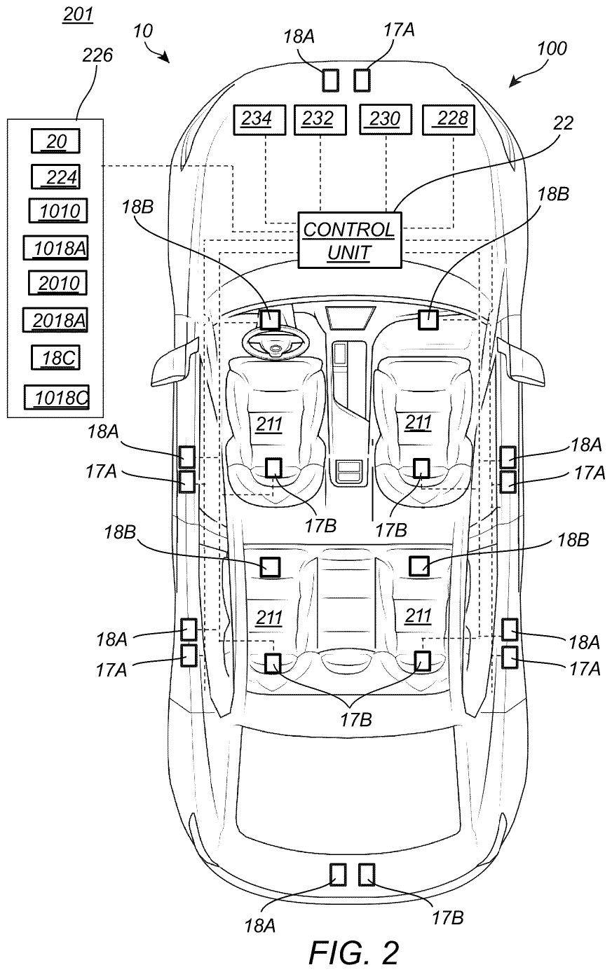

Referring now to FIG. 2, a schematic diagram of an exemplary embodiment of a vehicle including or suitable for use with a system for active monitoring of a stowed vehicle is illustrated in accordance with aspects of the present subject matter. As shown, the vehicle 10 may generally include the system 100 for active monitoring of a stowed vehicle and/or components thereof, as described herein. As shown, the vehicle 10 generally includes a plurality of seats, seat assemblies, occupant suites, or the like (seat assemblies 211 of FIG. 2). As further illustrated, the vehicle 10 and/or system 100 may include one or more noise generators 17, environmental sensors 18, and the control unit 22 as described above with respect to FIG. 1. The number, position, and orientation of such components are illustrated in FIG. 2 to provide an example, and it should be appreciated that alternative embodiments of the vehicle 10 may include fewer, additional, or alternatively configured components so long as such components are suitable to implement the logical steps and/or method elements disclosed herein. While each seat assembly 211 of FIG. 2 is illustrated with one or more associated or dedicated internal noise generators 17B and internal environmental sensors 18B, some vehicles 10 and/or systems 100 may not include an internal environmental sensor 18B for each seat assembly 211. For example, only a portion of the seat assemblies 211 may be provided with a dedicated cabin microphone, camera, or the like, such as some but not all of the rear seat assemblies 211.

Furthermore, other embodiments of the vehicle 10 and/or system 100 may include or be associated with more, fewer, or differently positioned/oriented external noise generators 17A and/or external environmental sensors 18A. For example, some embodiments may include a single bird's-eye-view (BEV) camera, a single microphone, and/or single external speaker at a central location (e.g., the roof of the vehicle 10), omitted from FIG. 1 for clarity. The operator seat 211, operator compartment, or the like may be provided with one more associated internal environmental sensors 18B or internal noise generators 17B in several embodiments. Alternatively or additionally, doors of the vehicle 10 adjacent to one another may share one or more external noise generators 17A and/or external environmental sensors 18A or even lack either or both of these components. Furthermore or alternatively, the one or more corners of the vehicle 10 may be provided with dedicated external noise generators 17A and/or external environmental sensors 18A. Some embodiments of the vehicle 10 and/or system 100 may not include the front external noise generator 17A, the front external environmental sensor 18A, the rear external noise generator 17A, and/or the rear external environmental sensor 18A. The vehicle 10 may also include the signaling hardware (e.g., blinkers, lights, etc. omitted from FIG. 2), which may also include some of the noise generators 17A.

As depicted in FIG. 2, at least some of the previous occupants of vehicle 10, such as at least the operator or owner of the vehicle 10 may be associated with a mobile device 20 (e.g., a cellular phone, tablet, laptop, MP4/MP3 audio device, smart watch, smart glasses, wearable technology, or the like). Thus and in some embodiments, the environmental sensor(s) 18 may include one more receivers/transceivers suitable to establish a wired or wireless connection (e.g., a near-field connection, a local area network connection, a Wi-Fi connection, a Bluetooth connection, or the like) between the vehicle 10, the system 100, and/or an associated control unit 22 and the mobile device(s) 20 of the occupant(s), operator(s), owner(s), etc. Optionally, one or more of such connections may be provided, at least partially, through the cloud 26 (as shown in FIG. 1).

In some embodiments, the vehicle 10 may be an electric vehicle having electrical components (e.g., one or more electric motors, associated batteries, etc.) for propelling the vehicle 10. Additionally or alternatively, the vehicle 10 may be configured with a rear-mounted or front-mounted internal combustion engine (ICE). In other embodiments, the vehicle 10 may be configured as a hybrid vehicle, which is driven by both a petroleum product (e.g., gas, diesel, jet fuel, and the like) and electrical power. Some embodiments of the vehicle 10 may include autonomous capability of varying degrees. It will be appreciated that the exemplary vehicle(s) 10 depicted and described herein are by way of example only, and, in other exemplary embodiments, the vehicle 10 may have any other suitable configuration, including, for example, any other suitable number of rows of seats, rows of doors, etc. Similarly, the vehicle 10 may have any other suitable number and position of doors, external noise generators 17A, internal noise generators 17B, external environmental sensors 18A, internal environmental sensors 18B, and the like. Additionally or alternatively and in other exemplary embodiments, any other suitable power sources may be provided. For example, the vehicle 10 may include a liquid or gaseous hydrogen powered engine, a gas turbine engine, an inboard motor, an outboard motor, etc.

While embodiments of the vehicle 10 herein may be illustrated or described as an automotive vehicle, it should be appreciated that the present disclosure is equally applicable to any other form of transportation (e.g., trains, boats, busses, passenger rail cars, and the like) where active monitoring of a stowed vehicle 10 is desired or required. Thus, regardless of the type of power train, design, or model of the vehicle 10, the vehicle 10 may include or be utilized with embodiments of the system 100, as described herein.

As shown, the vehicle 10 and/or system 100 may further include the control unit 22 (e.g., an electronic control unit, multiple associated control units, and/or a combination of one or more processing devices and at least one memory or memory device as described herein) communicatively coupled to the noise generator(s) 17, the environmental sensor(s) 18, the mobile device(s) 20 of the occupant(s)/owner(s)/operator(s), and/or other components of the vehicle 10 and/or system 100. The control unit 22 may be configured to direct operation of one or more of such components in accordance with aspects of the present subject matter. While a single control unit 22 is illustrated in FIG. 2 for simplicity, it should be appreciated that the control unit 22 may include multiple associated control units that together are configured to provide operational control of the vehicle 10, the system 100, the noise generator(s) 17, the environmental sensor(s) 18, the mobile device(s) 20 of the occupant(s), and/or other components of the vehicle 10 and/or system 100, such internal screens, touchscreens, displays, or the like of the vehicle 10.

Generally, the control unit 22 may be configured to receive a signal or data indicative of an environmental context surrounding the vehicle 10 or within an internal environment or cabin of the vehicle 10, such as an audio and/or visual environment, an indication of the wide area 11 surrounding the vehicle 10, an indication of the vicinity 12 surrounding the vehicle, and/or vehicle parameters. Based on such received signals or data or in response to, the control unit 22 may generally determine whether the operational status of the vehicle is stowed; determine an occurrence of a suspicious event or potentially suspicious event in the vicinity 12 of the stowed vehicle 10; monitor the vicinity 12 of the stowed vehicle 10, the suspicious area, or the potentially suspicious with increased scrutiny; confirm the suspicious event, if required; facilitate a one-way or two-way communication link (e.g., audio and/or video call) between the vicinity 12 and the mobile device 20; and/or cause data indicating the suspicious event 24 to be stored.

Furthermore and as shown in FIG. 2., the control unit 22 may receive vehicle parameters from various additional or alternative components of the vehicle 10 or components associated with the vehicle 10 to similarly provide operational control, feedback, or input information, as described in more detail below. Furthermore, the control unit 22 may include or be communicatively coupled with one or more external devices 226, such as the mobile device 20, the second vehicle 1010, the remote camera 1018A of the second vehicle 1010, the third vehicle 2010, the remote camera 2018A of the third vehicle 2010, the remote camera 18C and/or associated device (e.g., vehicle or infrastructure device), the remote camera 1018C and/or associated device (e.g., vehicle or infrastructure device), additional or fewer remote cameras, a remote device 224 (e.g., memory device, server, cloud system 26), or the like. In some embodiments, the external device(s) 226, the mobile device(s) 20, the remote device 224, and/or the cloud 26 may function as a repository of stored data indicating or associated with previously determined suspicious events.

While some communication links in FIG. 2 may be illustrated as joint communication links, it should be appreciated that one or more components communicatively coupled to the control unit 22, such as all of the components, may have component dedicated communication links (e.g., wireless or wired communication links with the control unit 22).

By applying an appropriate algorithm in the control unit 22, the system 100 can be integrated with the rest of the vehicle systems, with input from/output to a vehicle power source 228 (e.g., one or more electric motors, ICE motors, or associated control systems, monitors, sensors, etc.), a vehicle power supply 230 (e.g., one or more batteries, gas tanks, or associated control systems, monitors, sensors, etc.), an infotainment unit or system (infotainment unit 232), an audio system 234 (e.g., one or more control systems, amplifiers, preamplifiers, or the like), the noise generator(s) 17, the environmental sensor(s) 18, the external device(s) 226, the mobile device(s) 20, the second vehicle 1010, the remote camera 1018A of the second vehicle 1010, the third vehicle 2010, the remote camera 2018A of the third vehicle 2010, the remote camera 18C and/or associated device, the remote camera 1018C and/or associated device, additional or fewer remote cameras, and/or the remote device 224. In several embodiments, some of such devices, such as all of such devices, may each include or be associated with a suitable mobile application, a suitable cloud application, and/or a suitable application programming interface configured to provide external information and/or instructions to the control unit 22.

In some embodiments, besides controlling the operation of the vehicle 10, system 100, and/or included or associated components thereof, the control unit 22 may also provide useful information to the operator via the mobile device(s) 20 and/or infotainment unit 232, such as a display or touch screen thereof. Associated user interface(s) may include one or more buttons, switches, touch screen capability, or the like allowing the operator/owner of the vehicle 10 to communicate inputs to the control unit 22 utilized to control operation of the vehicle 10, system 100, and/or components or subsystems thereof.

With respect to the external environmental sensor(s) 18A, such sensors 18A may generally be configured to communicate one or more signals suitable for the control unit 22 to determine the suspicious event 24 including, without limitation, a suspicious impact 24A an individual or group outfitted for vandalism or theft, a lingering individual or group, a sudden movement, the sound of breaking glass, a sound or visual indicator associated with an alarm within the vicinity 12 and/or the wide area 11 surrounding the stowed vehicle 10, and/or sounds associated with keying a vehicle's paint (suspicious event 24B); and/or a person requiring help or medical assistance within the vicinity 12 and/or the wide area 11 surrounding the stowed vehicle 10 (suspicious event 24C). The signal(s) communicated from such sensor(s) 18A may further indicate the relative position and orientation of the pedestrian(s), vehicle(s), object(s), or the like associated with the suspicious event 24, characteristics of pedestrian(s), vehicle(s), object(s), or the like; an indication of the type of environment surrounding the stowed vehicle 10 (e.g., remote, urban, private property, parking lot, forest, planes, etc.); transitory conditions of the external environment surrounding the stowed vehicle 10 (e.g., weather, lighting conditions, wind direction, traffic density, etc.); external environmental noise; and/or characteristics of the external environmental noise.

With respect to the internal environmental sensor(s) 18B, such sensors 18B may generally be configured to communicate one or more signals suitable for the control unit 22 to determine, without limitation, that the vehicle 10 is unoccupied. In several embodiments, each of the second vehicle 1010 and/or third vehicle 2010 may be configured the same as or similar to the vehicle 10 with the same or similar system (e.g., system 1100 and/or 2100) and include some or all of the other components of the vehicle 10 and/or system 100 or compatible components.

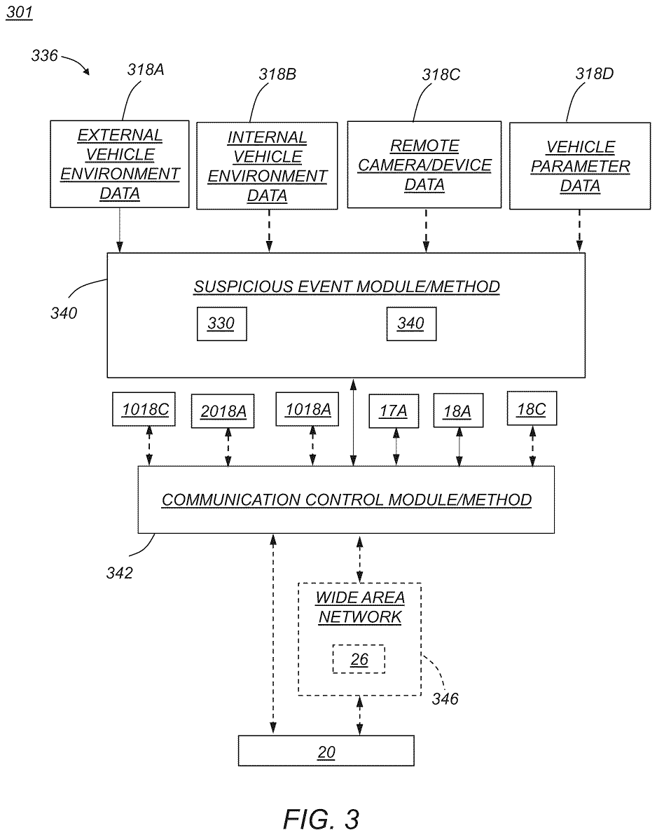

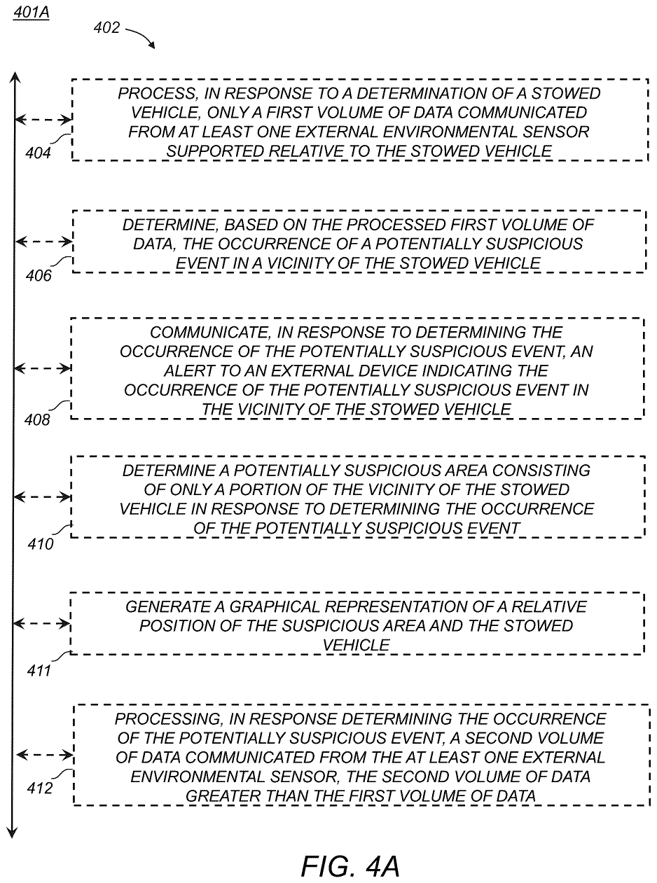

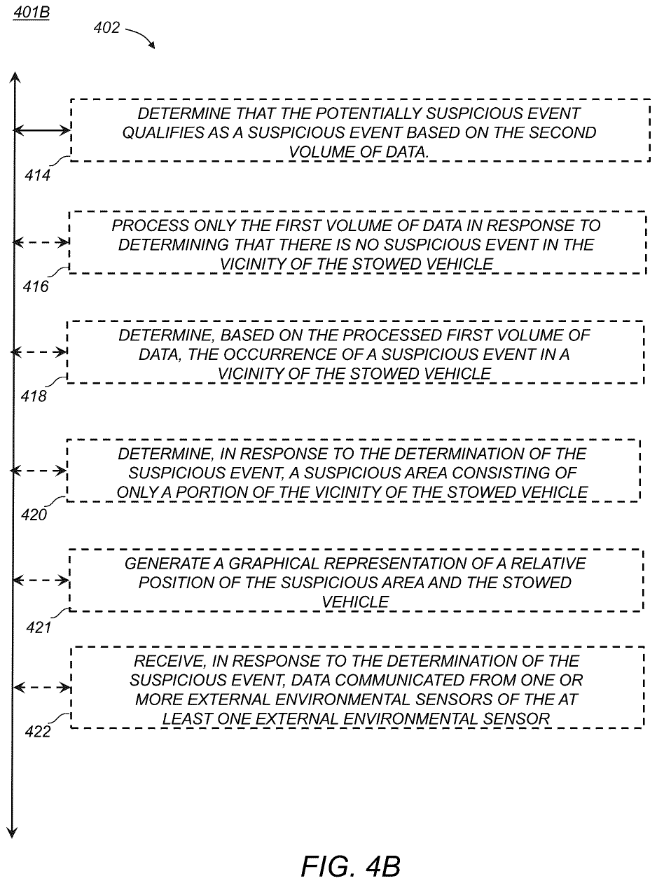

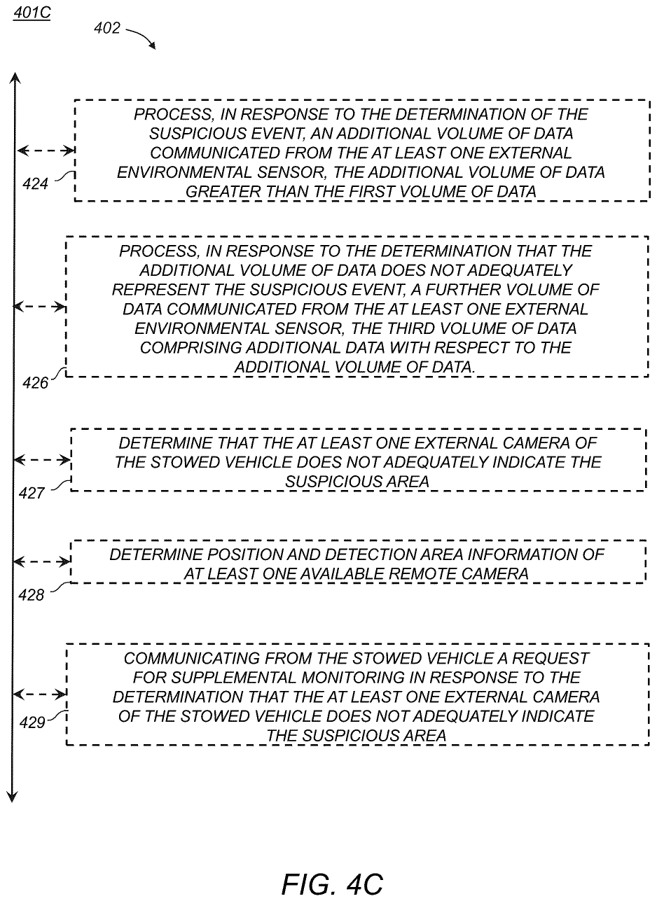

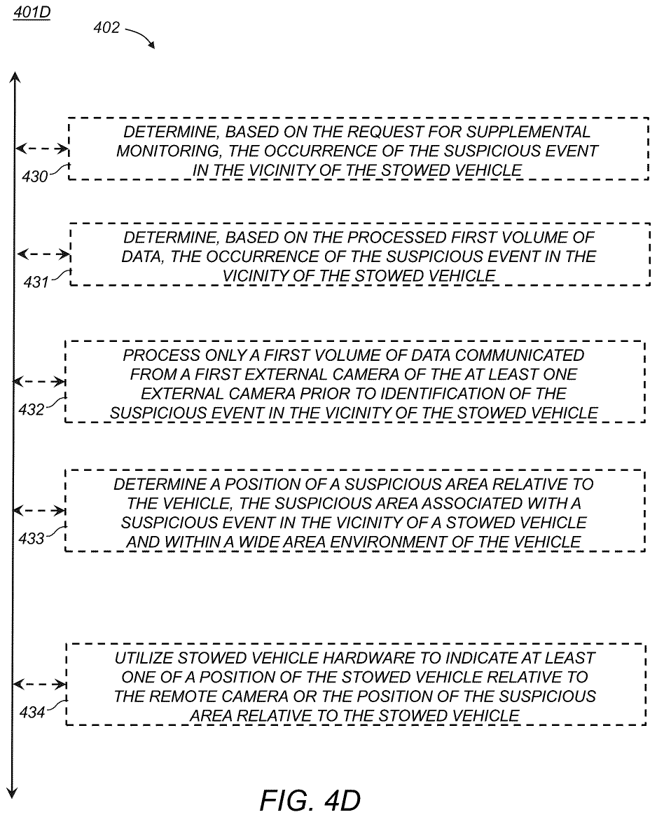

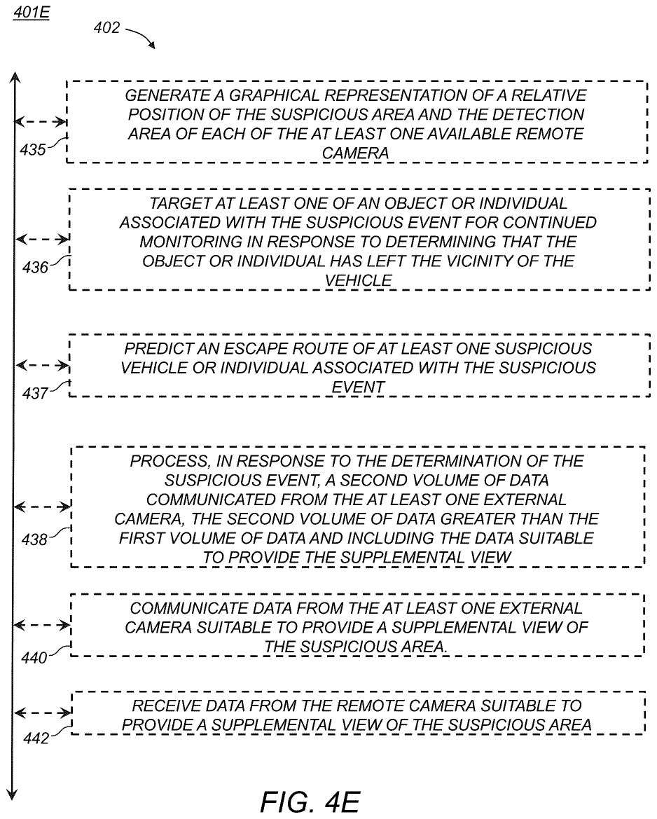

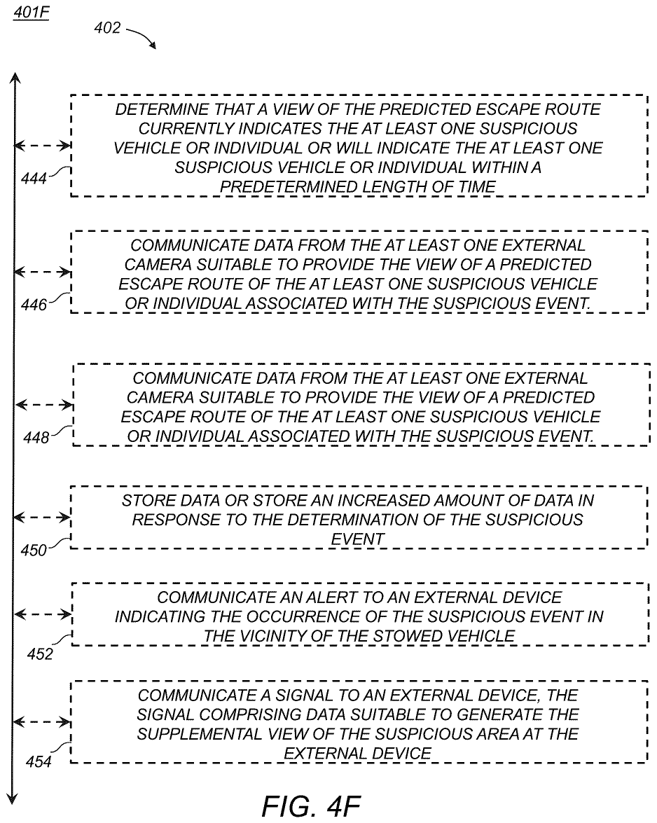

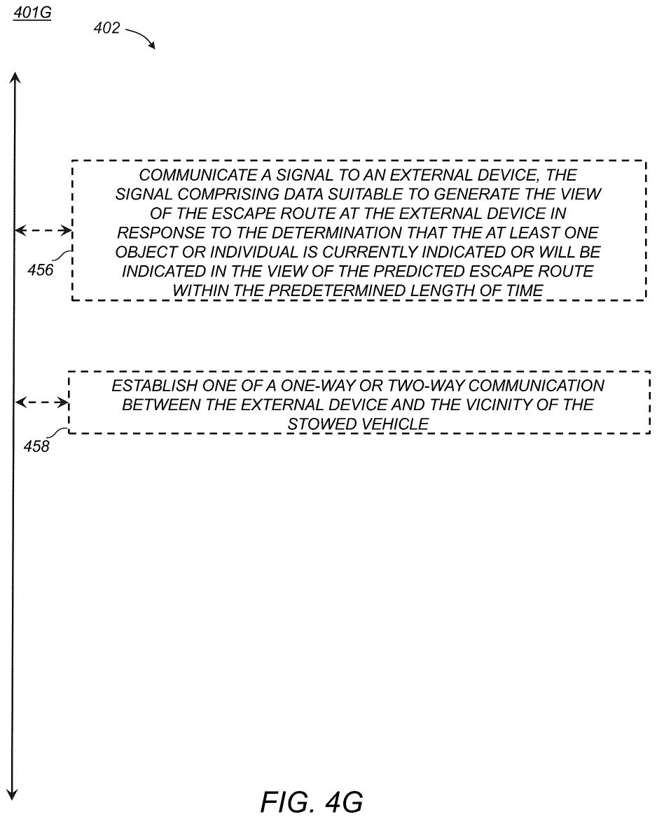

Referring now to FIGS. 3-4, FIG. 3 illustrates a schematic logic diagram of an exemplary embodiment of a system for active monitoring of a stowed vehicle in accordance with aspects of the present subject matter; FIG. 4A illustrates method elements, one or more of which may be implemented in a method for active monitoring of a stowed vehicle in accordance with aspects of the present subject matter; FIG. 4B illustrates additional or alternative method elements, one or more of which may be implemented in a method for active monitoring of a stowed vehicle in accordance with aspects of the present subject matter; FIG. 4C illustrates additional or alternative method elements, one or more of which may be implemented in a method for active monitoring of a stowed vehicle in accordance with aspects of the present subject matter; FIG. 4D illustrates additional or alternative method elements, one or more of which may be implemented in a method for active monitoring of a stowed vehicle in accordance with aspects of the present subject matter; FIG. 4E illustrates additional or alternative method elements, one or more of which may be implemented in a method for active monitoring of a stowed vehicle in accordance with aspects of the present subject matter; FIG. 4F illustrates additional or alternative method elements, one or more of which may be implemented in a method for active monitoring of a stowed vehicle in accordance with aspects of the present subject matter; and FIG. 4G illustrates additional or alternative method elements, one or more of which may be implemented in a method for active monitoring of a stowed vehicle in accordance with aspects of the present subject matter.

The logic diagram depicted in FIG. 3 (control logic 336) and/or the method or process (method 402) depicted in one or more of FIGS. 4A-4G may be utilized to control or in association with embodiments of the stowed vehicle 10 and/or the system 100 as described above with respect to FIGS. 1-2, any of the components or subsystems thereof, such as the noise generator(s) 17, the environmental sensor(s) 18, the control unit 22, the external device(s) 226, the mobile device(s) 20, the remote device(s) 224, vehicle power source(s) 228, the vehicle power supply(ies) 230, infotainment unit 232, an audio system 234 (if not already included or embedded within control unit 22), other control systems or monitoring system of the vehicle 10, such as an electronic vehicle control system configured to provide general operational control of the vehicle 10, or other systems or components utilized in association with operation of the vehicle 10, such as navigation systems and/or a global positioning system, sensors, etc. However, it should be appreciated that the control logic 336 and/or the method 402 may be utilized to control or in association with embodiments of other similar or suitably configured vehicles, systems for active monitoring of a stowed vehicle, and/or components or subsystems thereof. The control logic 336 may include one or more modules including instructions stored in at least one memory and executable by one or more processors to cause the processor(s) to implement steps, method elements, or the like as described herein. For example, elements of the control logic 336 and/or method 402 may be implemented, at least in part, by the control unit 22 and stored in memory associated with the control unit 22 and/or included with or accessible by the stowed vehicle 10.

The control logic 336 may include one or more modules such as suspicious event module 340 and/or multiple modules, sub-routines, or the like suitable to execute at least one, some, or all of the elements of method 402. The suspicious event module 340 may include instructions stored in at least one memory and executable by one or more processors to cause the processor(s) to implement steps, method elements, or the like as described herein. For example, elements of the control logic 336 and/or method 402 may be implemented, at least in part, by the control unit 22 and stored in memory associated with the control unit 22 and/or included with or accessible by the stowed vehicle 10.

The suspicious event module 340 is generally configured to determine whether the vehicle 10 is stowed and/or the occurrence of a suspicious event 24 at the stowed vehicle 10, the vicinity 12 of the stowed vehicle 10, and/or the wide area 11 of the stowed vehicle 10. Some or all of such determinations may be based on the environmental context surrounding the stowed vehicle 10 (e.g., external vehicle environment data 318A received or sensed from any of the external environmental sensors 18A); the internal or cabin environment of the stowed vehicle 10 (e.g., internal vehicle cabin data 318B received or sensed from any of the internal environmental sensors 18B); data provided by the remote camera(s) 18C, 1018C, 1018A, 2018A and/or associated devices, vehicles, or similarly configured vehicles 1010, 2010 (e.g., remote camera and/or device data 318C); characteristics or parameters (vehicle parameters) of one or more components or systems included in or associated with the stowed vehicle 10 (e.g., vehicle parameter data 318D); and/or information indicated from one or more occupant profiles (one occupant profile 340 depicted in FIG. 3 for simplicity) stored or accessible by the system 100 and/or stowed vehicle 10.

The control logic 336 and/or method 402 may additionally or alternatively include receiving data communicated from the least one external environmental sensor and indicating the environmental context surrounding the vehicle. For example, external vehicle environmental data 318A may be communicated from one or more of the external environmental sensors 18A and indicating the environmental context surrounding the stowed vehicle 10, such as the vicinity 12 of the stowed vehicle 10, such as the wide area 11 of the stowed vehicle 10, as described herein. The logic 336 and/or method 402 may additionally or alternatively include receiving the remote camera/device data 318 communicated from one or more of the remote cameras in response to request by the stowed vehicle 10 and/or automatically by the remote camera(s) in response to detection of the suspicious event 24 in the vicinity 12 of the stowed vehicle 10.

The control logic 336 and/or method 402 may additionally or alternatively include receiving data communicated from at least one internal environmental sensor and indicating at internal environment of the vehicle. For example, internal vehicle environmental data 318B may be communicated from the internal environmental sensor(s) 18B and indicate the internal environment or cabin environment of the vehicle 10. The control logic 336 and/or method 402 may additionally or alternatively include receiving vehicle parameter data 318D communicated from one or more components or systems included in or associated with the stowed vehicle 10 and/or system 100, e.g., engine parameters, geographical location, elevation information, power supply information, or the like.

Additionally or alternatively, the control logic 336, the method 402, or parts or components thereof may generally be implemented utilizing one or more artificial intelligence algorithms (AI algorithm(s) 330). For example, determining that the vehicle 10 is stowed, determining characteristics of the vicinity 12 and/or wide area 11 of the stowed vehicle 10, identifying people or objects within the vicinity 12 and/or wide area 11 of the stowed vehicle 10, determining characteristics of people or objects within the vicinity 12 and/or wide area 11 of the stowed vehicle 10, determining the occurrence or potential occurrence of a suspicious event 24, identifying the type of suspicious event 24, determining a suspicious area of the suspicious event 24, and/or updating any of these determination based on some or all of data 318 may be performed utilizing the artificial intelligence algorithm(s) 330.

The AI algorithm(s) 330 may include one or more algorithms, programs, modules, and the like suitable to simulate intelligence human behavior or perform tasks historically requiring human implementation. For example, the AI algorithm(s) 330 may include, without limitation, one or more of machine learning algorithms, artificial neural networks, recurrent artificial neural networks, feedforward neural networks, convolutional neural networks, recurrent neural networks, deep neural networks, natural language processing algorithms, long short term memory networks, inductive logic programming algorithms, support vector machines, clustering algorithms, Bayesian networks, reinforcement learning algorithms, representation learning algorithms, similarity and metric learning algorithms, sparse dictionary learning algorithms, genetic algorithms, k-nearest neighbor (KNN) algorithms, decision tree learning algorithms, association rule learning algorithms, and the like. Some of the AI algorithm(s) 330 described herein may be trained (via a supervised or unsupervised training process) based on training data provided to the AI algorithm(s) 330.

For instance, several embodiments of the AI algorithm(s) 330 are operable for using external environmental inputs, internal environmental inputs, and/or vehicle parameter inputs to identify suspicious events 24 (including potential suspicious events) within the vicinity 12 and/or wide area 11 of the stowed vehicle 10 and determine suspicious areas containing or associated with the suspicious events 12. A suspicious area is generally the immediate area surrounding a suspicious event 24, such as the area within a predetermined range around the suspicious event 24, e.g., within two feet of the suspicious event 24, within three feet of the suspicious event 24, or within five feet of the suspicious event 24. Alternatively, the suspicious area may be a range around the suspicious event 24 determined utilizing the AI algorithm(s) 330 and based on the identified type of suspicious event 24 (e.g., 24A, 24B, 24C) and/or determined characteristics of the vicinity 12 or wide area 11 of the stowed vehicle 10 or people or objects therein.

In some embodiments, the AI algorithm(s) 330 may determine the appropriate external environmental sensors 18A, external noise generators 17A, and/or remote cameras (e.g., 18C, 1018C, 1018A, 2018A) to utilize to monitor the suspicious event 24 and/or associated area or to establish a communicative link between the mobile device 20 and the suspicious event 24 within the vicinity 12. For instance, the communicative link may be a one-way audio communication contemporaneously and continuously relayed (e.g., a real-time audio feed) or a previously recorded message; a two-way continuous and contemporaneous audio communication (e.g., an audio call); and/or a one-way video communication contemporaneously and continuously relayed (e.g., a real-time video feed). In some configurations, the AI algorithm(s) 330 may determine or adjust volume levels of any audio call or message generated in the vicinity 12 of the stowed vehicle 10 utilizing the external noise generator(s) 17A based on the audio environment of the vicinity 12 and/or the relative position and orientation between the suspicious event 24 or suspicious area and the stowed vehicle 10 or the utilized external noise generator(s) 17A.

In one optional configuration, the AI algorithm(s) 330 utilizes a neural network (NN), such as a convolutional neural network (CNN), that is trained to segment and annotate images and/or identify sounds based on experiential learning. The AI algorithm(s) 330 may utilize computer vision (CV), computer hearing (CH), and/or deep learning (DL) algorithms applied to the obtained images and/or sounds to enables both object and scenario detection, as well as wide area 11 condition detection—is the scene urban, rural, a mountain, a seashore, a bridge; is the wide area 11 and/or vicinity 12 wet, slippery, windy, is there an accident, unconscious pedestrian, or an emergency vehicle; etc.?

Such process may further enable both interior and external situational awareness—is the vehicle 10 unoccupied or is the operator simply taking a nap in the vehicle 10; is the vicinity 12 and/or wide area 11 noisy, crowded, a high-foot-traffic area, quiet, a low-foot-traffic area? Thus, the external noise generator(s) 17A and associated software implement machine learning (ML) and algorithms to audio and/or video signals to alter or change the audio production, the generated sound intensity, and/or the utilized external noise generators 17A or number thereof responsive to certain conditions or characteristics of the external environment of the stowed vehicle 10 or the determined suspicious event 24. The present disclosure is agnostic related to these AI methodologies, and any suitable AI methodologies may be utilized equally.

The control logic 336 and/or method 402 may additionally or alternatively include identifying an occupant profile associated with the previous occupant, operator, or the like of the stowed vehicle 10 and/or the mobile device 20 associated with such occupant. For example, the internal environmental data 318B during the previous trip of the stowed vehicle 10 may indicate one or more characteristics of the previous occupant of the stowed vehicle 10 and may be utilized to identify the occupant profile 340 and/or mobile device 20 associated with the previous occupant in questions. In several instances, the AI algorithm(s) 330 may be utilized to identify an occupant profile 340 of multiple occupant profiles 340 stored at or accessible by the vehicle 10 and/or system 100 based on the internal vehicle environment data 318B. Alternatively, the occupant profile 340 and/or mobile device 20 may be determined based on the last mobile device 20 communicatively linked with the stowed vehicle 10. In several embodiments, the mobile device 20 includes the mobile device 20 of the owner in addition to any determined mobile device of the last operator of the stowed vehicle 10.

The control logic 336 and/or method 402 may additionally or alternatively include determining a status of the stowed vehicle as stowed. For instance, the suspicious event module 340 and/or AI algorithm(s) 330 may determine that that the vehicle 10 is a stowed vehicle based, at least in part, on the internal vehicle environment data 318B and/or the vehicle parameter data 318D. For instance, determining that the vehicle 10 is a stowed vehicle may include determining that the vehicle 10 is parked, out of gear, off, or the like. Additionally or alternatively, determining that the vehicle 10 is a stowed vehicle may include determining that the vehicle is unoccupied. Determining whether the vehicle 10 is occupied may be based on the internal vehicle environment data 318B, e.g., sensed or provided via the internal environmental sensor(s) 18B (FIG. 1). In some situations and/or embodiments, the internal vehicle environment data 318B may include an indication that the system 100 and/or control unit 22 has been communicatively coupled to one or more mobile devices 20 of current occupants. Thus, the coupling of the control unit 22 with the mobile device(s) 20 may indicate, at least, that the vehicle 10 is occupied and/or a minimum number of occupants of the vehicle 10. It should be appreciated that, if the vehicle 10 is determined to be occupied, the method 402 and/or process of the suspicious event module 340 may end. It should further be appreciated that various embodiments of the method 402 and/or disclosed system 100 are primarily directed to providing active monitoring of a stowed vehicle, and there is no need to monitor the vehicle 10 and/or its surroundings for suspicious events 24 if the vehicle 10 is occupied or operating (currently driven by an operator).

Referring still to FIGS. 3 and 4A, the control logic 336 and/or the method 402 may additionally or alternatively include processing, in response to a determination of the stowed vehicle, only a first volume of data communicated from the at least one external environmental sensor (method element 404). Thus, the method 402 may include and/or the suspicious event module 240 or control unit 22 may be configured to receive a signal communicated from the external environmental sensor(s) 18A in response to the determination of the stowed vehicle 10. In some such embodiments or different embodiments, the control logic 336 and/or the method 402 may include processing the first volume of the external environmental data 318A in response to a determination that the mobile device 20 of the operator (previous operator), owner, occupant, etc. is outside of the wide area 11 surrounding the stowed vehicle 10. The determination that the mobile device 20 is outside of the wide area 11 may be made at the mobile device 20 and communicated to the vehicle 10, system 100, and/or control unit 22; and/or such determination may be at the control unit 22 based on wireless or nearfield connectivity with the mobile device 20 and/or the external vehicle environmental data 318A.

In some embodiments, the external environmental sensor(s) 18A may include one or more audio sensors (e.g., microphones or the like) suitable to capture an audio environment or audio feed of the vicinity 12 and/or wide area 11 of the stowed vehicle 10. Furthermore or alternatively, the external environmental sensor(s) 18A may include one or more visual sensors (e.g., cameras, proximity sensors, or the like) suitable to capture a visual environment or visual feed of the vicinity 12 and/or wide area 11 of the stowed vehicle 10.

The first volume of external environmental data 318A may include data communicated from a subset of the external environmental sensor(s) 18A (e.g., a first external environmental sensor 18A), such as a BEV camera. The first volume of external environmental data 318A may additionally or alternatively include data communicated the external environmental sensor(s) 18A at a first time interval. In various embodiments, the vehicle 10, system 100, and/or control unit 22 may be configured to power or transition an external environmental sensor 18A from standby or an off setting/state to a fully-powered or on setting/state while actively sensing the external environment of the stowed vehicle 10 and/or communicating signals indicative of the external environment of the stowed vehicle 10 to the control unit 22, the suspicious event module 340, and or a communication control module or method (communication control module 342 of FIG. 3), which is described in more detail in the below description.

It should be appreciated that the first volume of the external environmental data 318A generally consists of a reduced or smaller volume of data relative to other received/processed data discussed herein (e.g., a second volume of data, a third volume of data, and/or additional or further data received or processed by the control unit 22 or in conjunction with the suspicious event module 340). Generally, the first volume of external environmental data 318A consists of a limited volume of data sufficient to monitor, at least, the vicinity 12 of the stowed vehicle 10 or potentially the wide area 11 of the stowed vehicle 10. Thus, resources of the stowed vehicle 10 and/or vehicle power supply 230 may be conserved while monitoring for suspicious events 24 prior to determining a suspicious event 24, especially prior to determining a suspicious event in the vicinity 12 of the stowed vehicle 10, by reducing the power necessary to operate the necessary external environmental sensor(s) 18A and/or the power required by the control unit 22 to process such first volume of data 318A and/or utilize the AI algorithm(s) 330 and to make the determination(s) discussed herein. The similarly configured vehicle(s) 1010 2010 may similarly process a first, reduced volume of data prior to determining at such vehicle(s) 1010, 2010 the occurrence of the suspicious event 24 in the vicinity 12 of the stowed vehicle 10 or prior to receiving a supplemental request for the supplemental view of the stowed vehicle 10.

It should be appreciated that such first volume of data 318A may not be stored or only transitorily stored in the absence of a determination of a suspicious event 24 (including a potentially suspicious event 24). Alternatively, the first volume of data 318A may be temporarily stored and regularly and automatically purged, e.g., after the next operation of the vehicle 10, after a few hours, after a day, or the like. Thus, the system 100 and/or control logic 336 conserves storage space of associated memory devices by either not storing the first volume of data 318A or regularly purging such first volume of data 318A in the absence of an associated suspicious event 24.

The first volume of data 318A may at least partially indicate the vicinity 12 of the stowed vehicle 10, such as the environmental context within a predetermined range of the stowed vehicle 10. For instance, the first volume of data 318A may indicate the vicinity 12 of the stowed vehicle 10 within a predetermined range of multiple of a front bumper of the stowed vehicle 10, a rear bumper of the stowed vehicle 10, a driver side of the stowed vehicle 10, a passenger side of the stowed vehicle 10, a front-driver corner of the stowed vehicle 10, a front-passenger corner of the stowed vehicle 10, a rear-driver corner of the stowed vehicle 10, and a rear-passenger corner of the stowed vehicle 10. Additionally or alternatively, the first volume of data 318A may indicate the vicinity 12 of the stowed vehicle 10 within a determined range based on the environmental context (audio or visual) of the vicinity 12 and/or wide area 11 based on the first volume of data 318A and/or determined utilizing the AI algorithm(s) 330. For example and in some embodiments, the vicinity 12 of the stowed vehicle 10 may include one or more determined ranges of multiple of the front bumper of the stowed vehicle 10, the rear bumper of the stowed vehicle 10, the driver side of the stowed vehicle 10, the passenger side of the stowed vehicle 10, the front-driver corner of the stowed vehicle 10, the front-passenger corner of the stowed vehicle 10, the rear-driver corner of the stowed vehicle 10, and the rear-passenger corner of the stowed vehicle 10.

The first volume of data 318A may indicate, at least partially, the wide area 11 of the stowed vehicle 10 including the vicinity 12 of the stowed vehicle 10. For example, the similarly configured vehicle(s) 1010, 1020 may process its corresponding first volume of data indicating the wide area 11 to identify suspicious events in the vicinity of the stowed vehicle 10 outside of its respective vicinity, as well as monitoring its respective vicinity for suspicious events as described herein. Generally and in some embodiments, the control unit 22 and/or AI algorithm(s) 330 may receive the first volume of data 318A in response to the determination of the stowed vehicle 10 and determine one or more characteristics of the environment surrounding the stowed vehicle 10, the vicinity 12 of the stowed vehicle 10, and/or the wide area 11 of the stowed vehicle 10. In some instances, the determined characteristics of the environment surrounding the stowed vehicle 10 may include the type of environment surrounding the stowed vehicle 10, transitory conditions of the external environment surrounding the stowed vehicle 10, an external ambient noise level (e.g., average, minimum, maximum, and/or range of the external sound intensity of the external environment surrounding the stowed vehicle 10, the vicinity 12, and/or wide area 11) and/or an external visual activity level (e.g., number or density of moving people, objects, etc. in the external environment surrounding the stowed vehicle 10, the vicinity 12, and/or wide area 11). In some instance, an initial determination of the characteristics of the environment surrounding the stowed vehicle 10, the vicinity 12 of the stowed vehicle 10, and/or the wide area 11 of the stowed vehicle 10 may be based on additional external vehicle environment data 318A up to all data measurable by the external environmental sensors 18A, and such determined characteristics may be confirmed utilizing the first volume of data 318A at the first time interval. Optionally appropriate ranges of the vicinity 12 and/or wide area may be determined, such as via the AI algorithm(s) 330, based on the determined type of surroundings of the stowed vehicle 10 and/or the determined characteristics of the environment surrounding the stowed vehicle 10.

As illustrated in FIGS. 3 and 4A, the control logic 336 and/or the method 402 may additionally or alternatively include determining, based on the processed first volume of data, the occurrence of a potentially suspicious event in a vicinity of the stowed vehicle, see method element 406. For example, the control unit 22 and/or AI algorithm(s) 330 may determine the potentially suspicious event 24 in the vicinity 12 of the stowed vehicle 10 based at least in part on the first volume of data 318A. Furthermore or alternatively, the similarly configured vehicle(s) 1010, 2010 may determine the occurrence of the potentially suspicious event in a wide environment of such similarly configured vehicle(s) 1010, 2010 and also in the vicinity 12 of the stowed vehicle 10. A potentially suspicious event 24, as used herein, may indicate a determined possibility of a suspicious event 24 above a threshold amount, e.g., 25% chance probability, but below a second threshold amount indicating the suspicious event 24, e.g., a 75% probability, an 80% probability, a 90% probability.

The method 402 may include and/or the suspicious event module 340 may be configured to determine the occurrence of the potentially suspicious event at the stowed vehicle 10 based, at least in part, on the audio environment or visual environment of the vicinity 12 of the stowed vehicle 10, the audio environment or visual environment of the wide area of the similarly configured vehicle 1010, 1020, and/or a determined type of environment of the stowed vehicle 10. A potentially suspicious event 24 or suspicious event 24, as utilized herein, may include, without limitation, the potential or probability over a threshold of any of the suspicious events 24A, 24B, or 24C as described herein. In some embodiments, the occurrence of the potentially suspicious event 24 at the stowed vehicle 10 may be based, at least in part, on a determination that environment the surrounding of the stowed vehicle 10 and/or wide area 11 is a suspicious area, e.g., a high-crime area. In such embodiments, the environmental sensor(s) 18 may include one or more sensors suitable to determine a current geographical location of the vehicle, e.g., a global position system (GPS), a GPS sensor, or the like; or, such information may be provided from other systems components of the stowed vehicle 10 such as a navigation system (e.g., vehicle parameter data 318D). In some embodiments, the control unit 22 and/or AI algorithm(s) 330 may determine the occurrence of the suspicious event 24 and/or the potentially suspicious event 24 based, at least in part, on one or more of a current geographical location of the stowed vehicle 10, a historical or current schedule of an operator of the stowed vehicle 10, a travel history of the stowed vehicle 10, historical parking locations of the stowed vehicle 10, or historical crime data associated with the current geographical location of the stowed vehicle 10. Such information may be included in the memory accessible by the control unit 22, data indicated or associated with the occupant profile 340, and/or provided by an external device 226 such as the mobile device 20, the remote storage 224, and/or the cloud 26.

The control logic 336 and/or the method 402 may additionally or alternatively include communicating, in response to determining the occurrence of the potentially suspicious event, an alert to an external device indicating the occurrence of the potentially suspicious event in the vicinity of the stowed vehicle (method element 408). For example, the control unit 22 may communicate or cause a signal, alert, or the like to be communicated to the mobile device 20 of the operator/owner of the stowed vehicle 10, such as via communication control module 342 discussed below.

As shown, the control logic 336 may include the communication control module 342 configured to alert the operator/owner of the stowed vehicle 10 (e.g., an operator/owner outside of the stowed vehicle 10, the surrounding of the stowed vehicle 10, and/or the wide area 11) of the occurrence of the suspicious event(s) 24 and/or the potential suspicious event 24 and provide relevant information, (e.g., locations, pictures, videos, audio recordings, and the like) via the mobile device 20. The communication control module 342 and/or associated steps of the method 402 may be configured to receive one or more commands (corrective actions) from the operator/owner via the mobile device 20 and to execute the corrective actions. Such corrective action may generally include playing an audio message in the vicinity 12 of the stowed vehicle 10 or establishing a communication link between the remote device 20 and the vicinity 12 of the stowed vehicle 10, such as a one-way continuous and contemporaneous audio connection (e.g., an audio feed), a one-way continuous and contemporaneous visual connection (e.g., a visual feed), or a two-way continuous and contemporaneous audio connection (e.g., an audio call). Thus, the remote operator/owner may monitor the vicinity 12 of the stowed vehicle 10, confirm potential suspicious events 24, and/or prevent or alleviate problems by communicating with individual in the vicinity 12 of the stowed vehicle 10 in real-time even though the operator/owner has left the area, such as at least the vicinity 12 and/or wide area 11. Additional details with respect to these communication links and the communication control module 342 are described below and in the context of a determined suspicious event 24.

The control logic 336 and/or the method 402 may additionally or alternatively include determining a potentially suspicious area consisting of only a portion of the vicinity of the stowed vehicle in response to determining the occurrence of the potentially suspicious event, see method element 410. For example, the control unit 22 and/or AI algorithm(s) 330 may determine the suspicious area surrounding the potentially suspicious event 24 utilizing the first volume of external vehicle environment data 318A. Additionally or alternatively, the control unit 22 and/or AI algorithm(s) 330 may determine the suspicious area surrounding the potentially suspicious event 24 utilizing the remote camera/device data 318C, in response to a request for such data 318C by the control unit 22 and/or stowed vehicle. In some instances, the remote camera/device data 318C may be automatically communicated by the similarly configured vehicle(s) 1010, 2010 in response to local determinations of the suspicious event 24.

In some such instances and embodiments, the control logic 336 and/or the method 402 may additionally or alternatively include determining a relative position and/or orientation of the determined suspicious area of the potentially suspicious event 24 relative to the stowed vehicle 10, one or more of the external environmental sensor 18A, and/or one or more of the external noise generator(s) 17A. Generally, the relative position and/or orientation may indicate three-dimensional position/orientation determinations indicating differences in elevation.

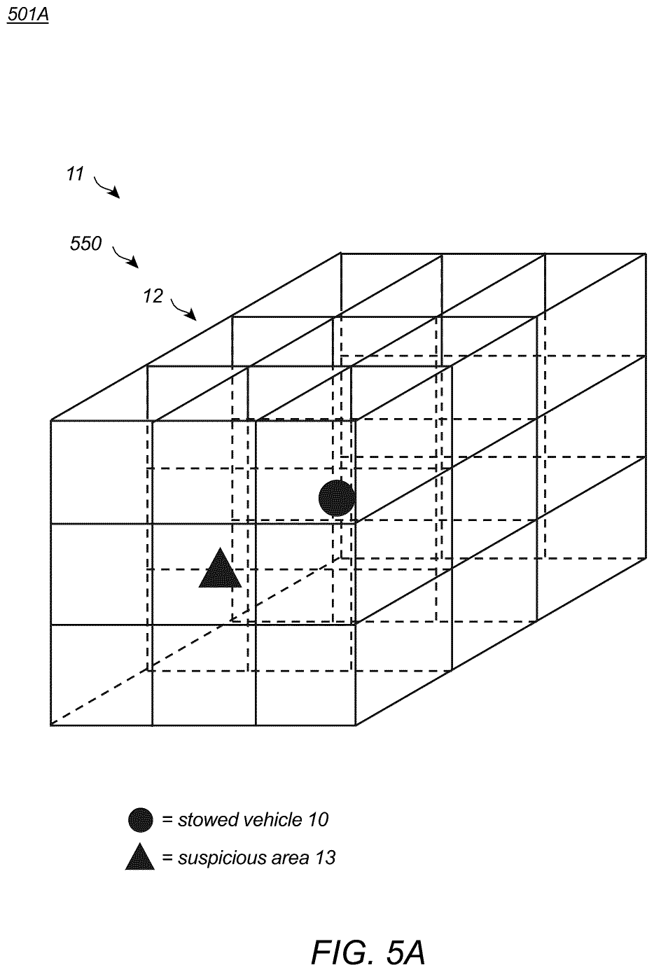

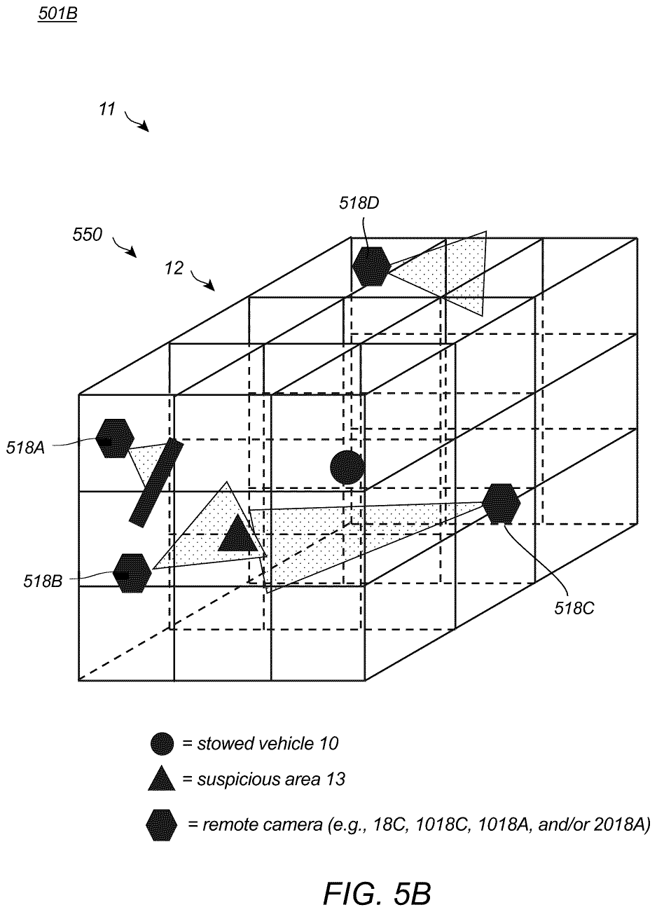

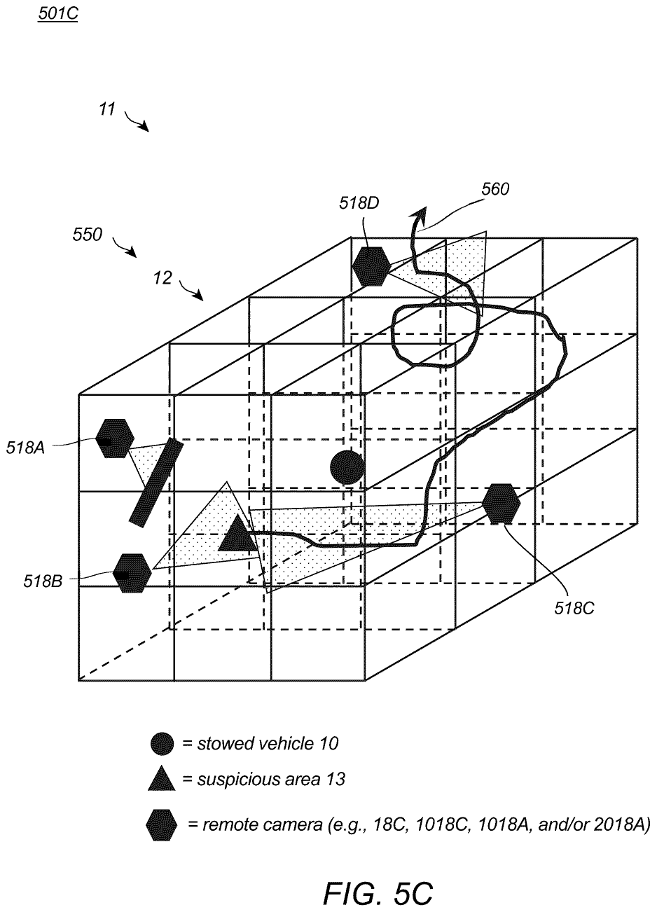

Referring still to FIGS. 3 and 4A, the control logic 336 and/or the method 402 may include generating a graphical representation of a relative position of the suspicious area and the stowed vehicle, see method element 411. For example and referring briefly to FIG. 5A, a schematic diagram of an exemplary embodiment of a graphical representation of a relative position of a suspicious area associated with a suspicious event (a potentially suspicious event in this context) and a stowed vehicle is illustrated in accordance with aspects of the present subject matter. The graphical representation 550 indicates the relative position including the relative height or elevation of the stowed vehicle 10 (black circle of FIG. 5A) and the suspicious area 13 (black triangle of FIG. 5A) of the potentially suspicious event 24. It should be appreciated that the relative position/orientation information and/or the generated graphical representation may be utilized by the control unit 22 and/or AI algorithm(s) 330 to identify which of the external environmental sensor(s) 18A are most suitable to provide additional data indicating the suspicious area 13 of the potentially suspicious event 24 and/or are most suitable to produce auditory messages, calls, and the like between the suspicious area and the mobile device 20.

The control logic 336 and/or the method 402 may additionally or alternatively include processing, in response determining the occurrence of the potentially suspicious event, a second volume of data communicated from the at least one external environmental sensor, the second volume of data greater than the first volume of data, see method element 412. For example, in response to determining the occurrence of the potentially suspicious event 24 (e.g., determined probability of as suspicious event 24 within threshold amounts, such as between 25% and 75%), the control unit 22 may receive a second volume of the external vehicle environment data 318A. The second volume of data 318A generally includes more data than the first volume of data 318A. In various instances, one or more additional external environmental sensors 18A may be activated, powered, or the like in response to the determined potentially suspicious event 24 and communicate the data to the control unit 22 for processing. For example, the second volume of data 318A may include data from a second external environmental sensor 18A identified as able or suitable (e.g., properly oriented) to provide more data or information indicating the potentially suspicious event 24 and/or the suspicious area thereof. Thus, the second volume of data 318A may include data from the second external environmental sensor 18A including additional data relative to the first volume of data 318A.

Referring now to FIGS. 3 and 4B, the second volume of data 318A may generally include more data indicating the potentially suspicious event 24 and/or the associated suspicious area relative to other portions of the vicinity 12 and/or wide area 11 of the stowed vehicle 10. The control logic 336 and/or the method 402 may additionally or alternatively include determining that the potentially suspicious event qualifies as a suspicious event based on the second volume of data, see method element 414. For example, the control unit 22 and/or AI algorithm(s) 330 may confirm that the potentially suspicious event 24 is a suspicious event 24 based, at least in part, on the second volume of data 318A similar to the initial determination of the potentially suspicious event 24 of method element 406.

In some embodiments and situations, the control logic 336 and/or the method 402 may additionally or alternatively include determining that there is no suspicious event in the vicinity of the stowed vehicle based on the processed second volume of data. For example, the control unit 22 and/or AI algorithm(s) 330 may determine that there is no suspicious event 24 in the vicinity 12 of the stowed vehicle 10 based, at least in part, on the second volume of data 318A. Determining that there is no suspicious event 24 in the vicinity 12 of the stowed vehicle 10 may include determining that the potentially suspicious event 24 has ended or that the potentially suspicious event 24 determined based on the first volume of data 318A is not a suspicious event (e.g., a nonsuspicious event). In response to the determining that the potentially suspicious event is not a suspicious event (e.g., a miscategorization based on only the first volume of data 318A), the second volume of data 318A may be treated the same as the first volume of data 318A, e.g., not retained by the system 100 or automatically purged as described above).

The control logic 336 and/or the method 402 may additionally or alternatively include processing only the first volume of data in response to determining that there is no suspicious event in the vicinity of the stowed vehicle, see method element 416. For instance, in the case that the control unit 22 and/or AI algorithm(s) 330 determine that there is no suspicious event 24 based on the second volume of data 318A, the control unit 22 may return to only processing the first volume of data 318A and/or causing only the first volume of data 318A to be communicated from the external environmental sensors 18A. It should be appreciated that if the control unit 22 and/or AI algorithm(s) 330 determine at any point that there is no suspicious event 24 or potentially suspicious event 24 within the vicinity 12 and/or wide area 11 of the stowed vehicle 12, the method 402 and/or module 340 may include returning to or continuing to process only the first volume of data 318A, see also method element 416. In one instance, the control unit 22 and/or AI algorithm(s) 330 may determine that there is no suspicious event 24 in the vicinity 12 of the stowed vehicle 10 based on the first volume of data 318A and continue to process only the first volume of data 318A. The similarly configured vehicle(s) 1010, 1020 may similarly return to processing corresponding, first, reduced volume of data in response to the determination made at the stowed vehicle 10 and/or locally that there is no suspicious event 24 in the vicinity 12 of the stowed vehicle 10, in the vicinity of the vehicle 1010, 1020, and/or in a wide area of the vehicle(s) 1010, 1020.

If the potentially suspicious event 24 is confirmed to be a suspicious event 24 (e.g., a verified suspicious event 24), the potentially suspicious area may be confirmed as the suspicious area of the verified suspicious event 24 (method element 420). Alternatively, the control unit 22 and/or AI algorithm(s) 330 may update the suspicious area if required (also method element 420), such as if the potentially suspicious area determined based on the first volume of data 318A and/or remote camera/device data 318C was inaccurate and/or if the associated area of the verified suspicious event 24 has moved since determination of the potentially suspicious area.

Furthermore, should the second volume of data 318A not indicate the updated or modified suspicious area, the control logic 336 and/or the method 402 may include receiving an additional volume of the external vehicle environment data 318A (e.g., a third volume of data 318A in such a situation), see method element 422. The additional/third volume of data 318A generally includes more data than the first volume of data 318A. In various instances, one or more additional external environmental sensors 18A may be activated, powered, or the like in response to the verified suspicious event 24 and communicate the data to the control unit 22 for processing. For example, the additional/third volume of data 318A may be provided by a third external environmental sensor 18A identified as able or suitable (e.g., properly oriented) to provide more data or information indicating the verified suspicious event 24 and/or the updated or modified suspicious area thereof. Thus, the additional/third volume of data 318A may include data from the third external environmental sensor 18A including additional data relative to the first volume of data 318A. Furthermore, the additional/third volume of data 318A may generally include more data indicating the verified suspicious event 24 and/or the updated suspicious area relative to other portions of the vicinity 12 and/or wide area 11 of the stowed vehicle 10.

Referring now to FIGS. 3 and 4C, the control logic 336 and/or the method 402 may additionally or alternatively include processing, in response to determining the occurrence of the suspicious event, an additional volume of data communicated from the at least one external environmental sensor, the additional volume of data greater than the first volume of data, see method element 424. For example and in the above context, the control logic 336 and/or the method 402 may additionally or alternatively include processing, in response to determining the occurrence of the suspicious event 24 based on the second volume of data 318A, the third volume of data 318A greater than the first volume of data 318A.

In some embodiments or situations, the first volume of data 318A may be sufficient for the control unit 22 and/or AI algorithm(s) 330 to determine the suspicious event 24 (e.g., a probability of the suspicious event 24 over predetermined or determined thresholds, e.g., a probability over 75%), see, e.g., method element 418. In such embodiments and context, the control logic 336 and/or the method 402 may additionally or alternatively include determining the suspicious area associated with the suspicious event (method element 420) similar to the determination of the potentially suspicious area as described above with respect to method element 410.

If the suspicious area has been updated or the graphical representation of the of the potentially suspicious event 24 and not been made, the control logic 336 and/or the method 402 may include generating a graphical representation of a relative position of the suspicious area and the stowed vehicle, see method element 421 (FIG. 4B). For example and referring again briefly to FIG. 5A, the graphical representation 550 may indicate updates to the relative position including the relative height or elevation of the stowed vehicle 10 (black circle of FIG. 5A) and the suspicious area 13 (black triangle of FIG. 5A) of the verified suspicious event 24 or may indicate initial relative position data when the first volume of data 318 is sufficient to determine the suspicious event 24.

Furthermore, the control logic 336 and/or the method 402 may additionally or alternatively include receiving additional external environment data 318 (also see method element 422) similar to receiving additional external environmental data 318 as described above with respect receiving the second volume of data 318A based on the determined potentially suspicious event 24 in the vicinity 12 of the stowed vehicle 10 or receiving the third volume of data 318A based on the verified suspicious event 24. As generally described above with respect to both situations, the additional external environment data 318A received includes more data than the first volume of data 318A, includes more data indicating the currently determined suspicious area than the first volume of data 318, and includes more data indicating the currently determined suspicious area relative to other portions of the vicinity 12 of the stowed vehicle 10.

Furthermore, the control logic 336 and/or the method 402 may additionally or alternatively include processing, in response to determining the occurrence of the suspicious event, an additional volume of data communicated from the at least one external environmental sensor, the additional volume of data greater than the first volume of data, see also method element 424. For example and in the above context, the control logic 336 and/or the method 402 may additionally or alternatively include processing, in response to determining the occurrence of the suspicious event 24 based on the first volume of data 318A, a second volume of data 318A greater than the first volume of data 318A.

For ease of discussion, further steps and method elements of the control logic 336 and the method 402 are described below for a situation where the control unit 22 was able to identify the suspicious event 24 based on the first volume of data 318A and subsequently received and processed the second volume of data 318A indicating the suspicious area, as described above. However, the following description is equally applicable to verified suspicious events 24 and verified suspicious areas where the current volume of data 318A indicating the verified suspicious area is a third volume of data 318A, in which case the following <number> volume of data 318A is increased by one.

In additional exemplary embodiments and situations, the control logic 336 and/or the method 402 may additionally or alternatively include determining that the second volume of data 318A does not adequately represent the suspicious event 24 and/or the associated suspicious area. For example, obstacles in the vicinity 12 of the stowed vehicle 10 may block or partially block the view and/or detection area of one or more of the external environmental sensors 18A, such an external camera. In some embodiments, the stowed vehicle 10 may only include a limited number of external environmental sensors 18A, such as camera. Thus, it is possible that the suspicious event 24 and/or associated area are between the sensible area of applicable external environmental sensors 18A. Thus, the control logic 336 and/or the method 402 may additionally or alternatively include processing, in response to the determination that the second volume of data does not adequately represent the suspicious event, a third volume of data communicated from the at least one external environmental sensor, the third volume of data comprising additional data with respect to the second volume of data (method element 426). For example and in the exemplary situation outlined in preceding paragraph. A third volume of the external vehicle environment data 318A may be communicated to the control unit 22 for processing in response to determining that the second volume of data 318A does not adequately represent the suspicious event 24 and/or the associated suspicious area.

For some configurations of the stowed vehicle 10 and applicable situations, the third volume of data 318 may be communicated from a far-range external environmental sensor 18A, such as a BEV camera. Thus, when the suspicious event 24 and/or suspicious area cannot be fully monitored by the external environmental sensors 18A, data indicating the wide area 11 surrounding the stowed vehicle 10 may be monitored and/or processed by the control unit 22. For example, the third volume of data 318A may indicate portions of the wide area 11 and/or vicinity 12 surrounding the suspicious event 24 and/or associated suspicious area when the second volume of data 318A does adequately represent the suspicious event 24 and/or associated suspicious area. Additionally or alternatively, the third volume of data 318A may include data communicated from external environmental sensors 18A and/or external cameras configured to capture or indicate areas adjacent to the suspicious area and/or that only partially indicate the suspicious area.

The control logic 336 and/or the method 402 may additionally or alternatively include determining that the at least one external camera of the stowed vehicle does not adequately indicate the suspicious area, see method element 427. In other words, the control unit 22 may determine that external cameras of the external environmental sensors 18A are not able to provide a view of the suspicious area of the suspicious event 24. In such a situation, the control logic 336 and/or the method 402 may include determining position and detection area information of at least one available remote camera, see method element 428. For example, the control unit 22 may determine and/or receive position and detection information of available and suitable remote cameras 18C, 1018C of infrastructure devices and vehicles without equivalent systems and/or remote cameras 1018A, 2018A of similarly configured vehicles 1010, 2010 including similar systems 1100, 2100 operable for targeted vehicle monitoring assistance.

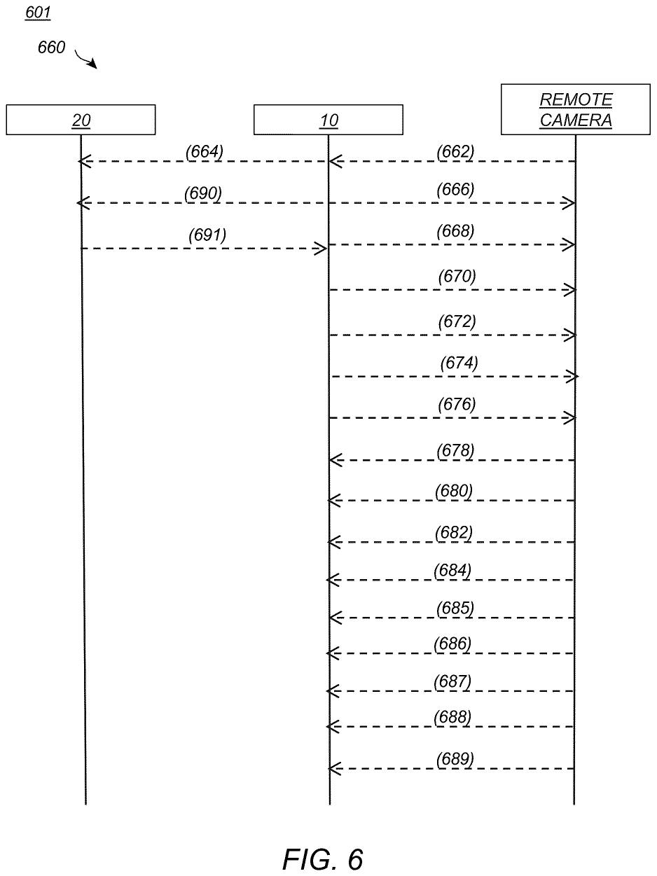

The control unit 22 may identify the remote camera(s) via a call-response-type broadcast, as explained in more detail below with respect to FIG. 6 and communication protocols disclosed herein. For example, the control logic 336 and/or the method 402 may include communicating from the stowed vehicle a request for supplemental monitoring in response to the determination that the at least one external camera of the stowed vehicle does not adequately indicate the suspicious area, see method element 429.

Referring now to FIGS. 3 and 4D and to the similarly configured vehicle(s) 1010, 2010 including similar system(s) 1100, 2100, such system(s) 1100, 2100 may also be configured to implement some or all of the logical elements of suspicious event module 340 and/or method 402, as context dictates. For example, the control logic 336 and/or the method 402 may include determining, based on a request for supplemental monitoring, the occurrence of the suspicious event in the vicinity of the stowed vehicle, see method element 430. For example, the system(s) 1100, 2100 and/or an associated control unit(s) may receive a request for supplemental monitoring from the stowed vehicle 10 indicating the occurrence of the suspicious event 24. Alternatively, the system(s) 1100, 2100, an associated control unit(s), and/or suitable AI algorithm(s) may locally determine the occurrence of the suspicious event 24 in the vicinity 12 of the stowed vehicle based on corresponding first volume of data, as explained in more detail above with respect to the stowed vehicle 10. Thus, the control logic 336 and/or the method 402 may include determining, based on the processed first volume of data, the occurrence of the suspicious event in the vicinity of the stowed vehicle, see method element 431. For example and in this context, the vehicle(s) 1010, 2010 and/or system(s) 1100, 2100 may determine the occurrence of the suspicious event 24 in the vicinity 12 of the stowed vehicle 10 based on the corresponding first volume of data processed and generated at the vehicle(s) 1010, 2010, such as by the remote camera(s) 1018A, 2018A thereof.

In some embodiments, the control logic 336 and/or the method 402 may include processing only a first volume of data communicated from a first external camera of the at least one external camera prior to identification of the suspicious event in the vicinity of the stowed vehicle, see method element 432. For example, the vehicle(s) 1010, 2010 and/or system(s) 1100, 2100 may only process the corresponding first volume of data communicated from a first external camera thereof prior to identification of the suspicious event 24 in the vicinity 12 of the stowed vehicle 10. Additionally or alternatively, the control logic 336 and/or the method 402 may include determining a position of a suspicious area relative to the vehicle, the suspicious area associated with a suspicious event in the vicinity of a stowed vehicle and within a wide area environment of the vehicle, see method element 433.

Additionally or alternatively, the control logic 336 and/or the method 402 may include utilizing stowed vehicle hardware to indicate at least one of a position of the stowed vehicle relative to the remote camera or the position of the suspicious area relative to the stowed vehicle, see method element 434. Generally, the previously described signaling hardware of the stowed vehicle 10 may be activated, pulsed, or the like to highlight the stowed vehicle 10 within the detection area(s) of the remote camera(s). For example, blinkers and flashers may be powered, pulsed, etc. to draw attention to the stowed vehicle 10 within the detection area(s) of the remote camera(s). Additionally or alternatively, one or more noise generators 17A (e.g., horn, siren, alarm, etc.) may be powered or pulsed to draw attention to the stowed vehicle 10 within the detection range of external environmental sensor(s) of the similarly configured vehicle(s) 1010, 2010. In some instances, only pulsing lights may be utilized to highlight the location of the stowed vehicle 10 in response to a potentially suspicious event 24 that has not been confirmed as a suspicious event 24. When there has been a determined or verified suspicious event 24, both lights and sounds may be utilized to highlight the stowed vehicle 10, which also draws pedestrian attention to the stowed vehicle 10 and potentially prevents vandalism of the stowed vehicle 10. Furthermore, which signaling hardware is activated and associated pulse characteristics may indicate the position of the suspicious area relative to the stowed vehicle 10 and/or the applicable signaling hardware.

Referring now to FIGS. 3 and 4E, the control logic 336 and/or the method 402 may include generating a graphical representation of a relative position of the suspicious area and the detection area of each of the at least one available remote camera, see method element 435. For example and referring briefly to FIG. 5B, a schematic diagram of an exemplary embodiment of a graphical representation indicating a relative position between remote cameras and detection areas thereof and a suspicious area associated with a suspicious event in a vicinity of a stowed vehicle is illustrated in accordance with aspects of the present subject matter. Thus and as shown in FIG. 5B, the graphical representation 550 may be generated with or updated to include an indication of available remote cameras 518 surrounding the stowed vehicle 10, such as remote cameras 518A, 518B, 518C, 518D, and/or additional or fewer remote camaras 518 as the situation dictates. The remote camera(s) 518 may include one or more of the remote cameras 18C, 1018C, 1018A, 2018A. The graphical representation 550 indicating the detection areas (patterned triangles) may be generated at the stowed vehicle 10 based on the data received from the remote camera(s) 518. Additionally or alternatively, the graphical representation 550 may be generated, at least in part, at the remote camera(s) 518, such as by a similarly configured vehicle(s) 1010, 2010 including the remote camera(s) 1018A, 2018A.

The value of each of the remote cameras 518 for monitoring the suspicious area 13 may be qualitatively assessed utilizing the generated graphical representation 550 at the stowed vehicle 10 and/or the vehicle(s) 1010, 2010 including the applicable remote camera(s) 1018A, 2018A. For example, remote cameras 518A and 518D may be assessed at a value of 3, indicating that the associated detection area does not capture the area of interest (e.g., the suspect area 13) at all, e.g., blocked by an object, wall, or the like as shown remote camera 518A and/or directed elsewhere as shown by remote camera 518D. As a further example, remote camera 518B may be assessed at a value of 1, indicating that the associated detection area fully captures the area of interest (e.g., the suspect area 13). As a still further example, remote camera 518C may be assess at a value of 2, indicating that the associated detection area partially captures the area of interest (e.g., the suspect area 13), e.g., at the edge of the detection range of the camera 518C, a partially blocked detection area, and/or a detection area only partially overlapping with the area of interest.

In some additional or alternative situations, the second volume of data 318A generated at the stowed vehicle 10 may not adequately represent the suspicious event 24 because an object or individual associated with the suspicious event has left the suspicious area associated with the suspicious event 24 and/or the vicinity 12 of the stowed vehicle 10. For example, the suspicious event 24 may include a hit-and-run-type incident or vandalism where a suspect flees the suspicious area, the vicinity 12, and/or the wide area 11 after committing a crime. Thus, in additional or alternative embodiments, the control logic 336 and/or the method 402 may additionally or alternatively include targeting at least one of an object or individual associated with the suspicious event for continued monitoring in response to determining that the object or individual has left the vicinity of the vehicle (method element 436). For example, the control unit 22 and/or AI algorithm(s) 330 may recognize that an object or individual associated with the suspicious event 24 has left the suspicious area, the vicinity 12, and/or the wide area 11 based on the second volume of data 318A. In some embodiments, the control unit 22, AI algorithm(s) 330, the similarly configured vehicle(s) 1010, 1020, and/or equivalent components may update the suspicious area associated with the suspicious event 24 continuously to reflect the current or real-time immediate area surrounding the suspicious event 24.

Additionally or alternatively, the control unit 22 and/or AI algorithm(s) 330 may determine an additional suspicious event 24 and associated additional suspicious area tied to the object or individual associated with the initial suspicious event 24. Furthermore, the control logic 336 and/or the method 402 may receive and process additional volumes of data 318A (e.g., third, fourth, fifth, etc.) potentially from the same, different, or a mix of external environmental sensors 18A of the updated suspicious area associated with a moved and/or continuously moving suspicious event 24 and/or the additional suspicious area associated with the additional suspicious event 24. It should be appreciated that the additional suspicious area may, in some situations, be continuously moving as well, e.g., a fleeing culprit of a hit and run.

Referring now briefly to FIG. 5C, a schematic diagram of an exemplary embodiment of a graphical representation indicating a predicted escape route of a suspicious vehicle and/or individual associated with the suspicious event is illustrated in accordance with aspects of the present subject matter. Additionally or alternatively, the control logic 336 and/or the method 402 may include predicting an escape route of at least one suspicious vehicle or individual associated with the suspicious event, see method element 437. For example, the graphical representation 550 of FIG. 5C has been generated to include or updated to include a predicted escape route 560 of the suspicious vehicle and/or individual associated with the suspicious event 24. The escape route 560 may be at least partially predicted at the stowed vehicle 10 and based on the external vehicle environmental data 318A, the remote camera/device data 318C, and/or the vehicle parameter data 318D and optionally utilizing the AI algorithm(s) 330. Additionally or alternatively, escape route 560 may be at least partially predicted at the similarly configured vehicle(s) 1010, 2010 similarly. The predicted escape route 560 may be generated based on travel history of the stowed vehicle 10 and/or similarly configured vehicle(s) 1010, 2010; global travel history information, navigation routing generated to leave the current area, or the like. Furthermore, the value of each of the remote cameras 518 for monitoring the predicted escape route 560 (at least a portion thereof) may be qualitatively assessed utilizing the generated graphical representation 550 at the stowed vehicle 10 and/or the vehicle(s) 1010, 2010 including the applicable remote camera(s) 1018A, 2018A similar to such assessment with respect to the suspicious area 13 as described with respect to FIG. 5B. For example, remote camera 518 D may be assessed at a value of 1 with respect to monitoring the predicted escape route 560, indicating that the associated detection area fully captures the area of interest (e.g., a portion of the predicted escape route 560).

The control logic 336 and/or the method 402 may include processing, in response to the determination of the suspicious event, a second volume of data communicated from the at least one external camera, the second volume of data greater than the first volume of data and including the data suitable to provide the supplemental view, see method element 438. For example, the similarly configured vehicle(s) 1010, 1020; the system(s) 1100, 2100; associated control units; and/or suitable AI algorithm(s) may process a second volume of data communicated from the remote camera(s) 1018A, 2018A greater than the first volume of data processed at such vehicle(s) 1100, 2100 in response to the determination of the suspicious event 24. The second volume of data generally includes or indicates the supplemental view of the suspicious event 24. It should be appreciated that the vehicle(s) 1010, 2010 may only process the second volume of data if the corresponding remote camera(s) 1018A, 2018A has a value assessment of 1 or 2 and preferably 1.

The control logic 336 and/or the method 402 may include communicating data from the at least one external camera suitable to provide a supplemental view of the suspicious area, see method element 440. For example, the vehicle(s) 1010, 2010 may communicate data 318C from the remote camera(s) 1018A, 2018A suitable to provide the supplemental view(s) of the suspicious area of the suspicious event 24. Similarly, the control logic 336 and/or the method 402 may include receiving data from the remote camera suitable to provide a supplemental view of the suspicious area, see method element 442. For example, the stowed vehicle 10 may receive the remote camera/device data 318C from the remote camera(s) suitable to provide the supplemental view of the suspicious area 24. Generally, the remote camera(s) 518 having the highest value for monitoring the suspicious area 13 and/or suspicious event 24 is chosen to communicate the remote camera/device data 318C, and/or the stowed vehicle 10 may only receive the data 318C from such high-value remote camera(s) 518.

Referring now to FIGS. 3 and 4F, in some embodiments and situations, the control logic 336 and/or the method 402 may additionally or alternatively include determining that a view of the predicted escape route currently indicates the at least one suspicious vehicle or individual or will indicate the at least one suspicious vehicle or individual within a predetermined length of time, see method element 444. Furthermore, the control logic 336 and/or the method 402 may include communicating data from the at least one external camera suitable to provide a view of the predicted escape route of the at least one suspicious vehicle or individual associated with the suspicious event, see method element 446. Additionally or alternatively, the control logic 336 and/or the method 402 may include receiving data from the remote camera or an additional remote camera suitable to provide a view of the predicted escape route, see method element 448. For example, the stowed vehicle may receive the remote camera/device data 318C from the remote camera(s) 518 suitable to indicate the predicted escape route 560.

In some embodiments and situations, the control logic 336 and/or the method 402 may additionally or alternatively include storing data or storing an increased amount of data in response to the determination of the suspicious event (see method element 450). For example, data 318A (e.g., second volume, third volume, forth volume, etc.) and/or data 318C received and/or processed by the control unit 22 and reflecting suspicious event 24, the suspicious area (e.g., a static suspicious area or updated suspicious area and/or a moving suspicious area or updated suspicious area), the additional suspicious event 24, the additional suspicious area (e.g., a static additional suspicious area and/or moving additional suspicious area) and/or the predicted escape route 560 may be stored locally (e.g., at the control unit 22 and/or stowed vehicle 10) and/or remotely (e.g., at the remote device 224, mobile device 20, the and/or the cloud 26).

Additionally or alternatively, the control logic 336 and/or the method 402 may include communicating an alert to an external device indicating the occurrence of the suspicious event in the vicinity of the stowed vehicle (method element 452). For example, the alert may be communicated from the stowed vehicle 10, the system 100, and/or the control unit 22 in response to the determined potentially suspicious event 24 and/or the suspicious event 24. In some embodiments and applicable situations, the control logic 336 and/or the method 402 may include communicating a signal to an external device, the signal comprising data suitable to generate the supplemental view of the suspicious area at the external device (method element 454).

Referring now to FIGS. 3 and 4G, the control logic 336 and/or the method 402 may include communicating a signal to an external device, the signal comprising data suitable to generate the view of the escape route at the external device in response to the determination that the at least one object or individual is currently indicated or will be indicated in the view of the predicted escape route within the predetermined length of time (method element 456).

In one exemplary embodiment, the control logic 336 and/or system 100 may include a communication control module 342 configured to communicate an initial signal to the mobile device 20 of the operator, owner, etc. of the stowed vehicle 10 outside of the stowed vehicle 10 in response to the determination of the suspicious event 24 and/or potentially suspicious event 24 within the vicinity 12 of the stowed vehicle 10. In some such embodiments, the initial signal is only communicated to the mobile device 20 after determining the status of the vehicle 10 as stowed. Additionally or alternatively, the initial signal may only be communicated if the mobile device 20 is determined to be outside of the vicinity 12 and/or wide area 11 of the stowed vehicle 10. Additionally or alternatively, the initial signal may generally indicate the occurrence of the suspicious event 24 and/or potentially suspicious event 24 and the position of the suspicious area or potentially suspicious area, respectively, relative to the stowed vehicle 10. The initial signal may further or alternatively indicate what kind of suspicious event 24 has occurred (e.g., one or the suspicious event 24A, 24B, 24C or other suspicious events 24). In various embodiments, the mobile device 20 may provide an alert, alarm, or the like to the remote occupant, operator, owner, etc. in response to receiving the initial signal. In at least some embodiments, the initial signal may include data indicative of an image, video, or audio recording of the suspicious event 24, associated suspicious area, and/or predicted escape route 560. It should be appreciated that the data provided in the communicated alert may be generated by the volume of the external environment data 318A and/or remote camera/device data 318C indicating the suspicious event 24 and/or suspicious area (e.g., the second volume, the third volume, a forth volume, etc. as context dictates) and/or the predicted escape route 560.

In some such embodiments or differently configured embodiments, the control logic 336 and/or the method 402 may include establishing one of a one-way or two-way communication between the external device and the vicinity of the stowed vehicle (method element 458). In various embodiments, the mobile device 20 may be configured to produce audio content or produce visual content included in the initial signal. In some embodiments, the data provided in the communicated alert may include a continuous stream of the external environment data 318A and/or remote camera/device data 318C indicating the vicinity 12, the suspicious event 24, the suspicious area, the wide area 11, and/or the predicted escape route 560. For example, the data provided in the communicated alert may include a video feed of a camera or audio feed of a microphone of the external environment data 318A, e.g., the volume of data 318A indicating the suspicious event 24 and/or suspicious area, such as second volume of data 318. The provided data may additionally or alternatively include a video feed of the remote camera(s) of the remote camera/device data 318C indicating the supplemental view of suspicious event 24, suspicious area, and/or predicted escape route 560. Such continuous audio and/or visual feed may be provided automatically within the initial signal. Additionally or alternatively, such continuous audio and/or visual feed may be provided selectively when requested by the operator/owner utilizing the mobile device 20.

In some embodiments or alternative embodiments, the method 402 may include and/or the communication control module 342 may be configured to establish a continuous, two-way audio or visual communication between the external device and the vicinity of the stowed vehicle 10. For example, the method 402 may include and/or the communication control module 342 may be configured to receive a response signal communicated from the mobile device 20 after communicating the initial signal. The response signal is generally indicative of one or more corrective actions to be performed by the stowed vehicle 10, the system 100, and/or a component or subsystem thereof. For example, the response signal may indicate interface input provided via the mobile device 20 (e.g., a button, dial, knob selection and/or a mobile device interface input with respect to a graphical user interface). For example, the occupant, operator, owner, etc. may make a selection indicating that the operator/owner wishes to initiate the two-way communication link with vicinity 12 of the stowed vehicle 10 and/or the suspicious area associated with the suspicious event 24. Alternatively, the two-way communication between the mobile device 20 and the vicinity 12 of the stowed vehicle 10 may be established automatically when the operator opens the alert and/or initial alert communicated from the stowed vehicle 10.

In several embodiments, the method 402 may include and/or the communication control module 342 may be configured to cause the corrective action(s) to be performed via the stowed vehicle 10, the system 100, and/or at least one component or subsystem thereof. If necessary, the method 402 may include and/or the system 100 may be configured to transition the stowed vehicle 10 and/or similarly configured vehicle(s) 1010, 2010 from off to on, from standby to on, or the like via the vehicle power supply 230, as necessary to implement the elements of the method 402, suspicious event module 340, and/or communication control module 342, as described herein. In one example, the corrective action(s) may include playing a prerecorded message via the external noise generator(s) 17A of the stowed vehicle 10. For example, audio communication (previously recorded or real-time as described below) may be communicated from external speakers of the stowed vehicle 10, such one or more external speakers closest to or oriented toward the suspicious area or a camera best indicating the suspicious event 24. In some embodiments, an omnidirectional external speaker and/or all of the external speakers of the stowed vehicle 10 may be utilized to produce such audio communication(s).

Thus, the corrective action(s) may include establishing a two-way communication link between the mobile device 20 (e.g., one or more included speakers and/or microphones thereof) and the external speaker(s) and/or the external environmental sensor(s) 18A configured as the external microphone(s). Furthermore or alternatively, the two-way communication link between the mobile device 20 and the stowed vehicle 10 or system 100 may include a video two-way communication link. Thus, the communication link may be additionally or alternatively facilitated by utilizing a display provided with the mobile device 20 and an external camera of the stowed vehicle 10 best indicating the suspicious event 24 and/or suspicious area. For example, such external camera may have been utilized to provide some of the volume of data 318A indicating the same (e.g., the second volume of data 318A or other volume of data, as context dictates).

Referring particularly to FIGS. 1 and 3 and as illustrated, the two-way communication link between the mobile device 20 and the stowed vehicle 10, system 100, the remote camera(s), and/or components or subsystems thereof (e.g., the external noise generator(s) 17A and/or external environmental sensor(s) 18A, such as one or more external cameras) may be provided via a near-field connection, a local area network, e.g., a wireless connection(s) with the stowed vehicle 10, system 100, remote camera(s), and/or included wireless receivers, transmitters, transceivers, or the like, such that the two-way communication link is provided through the control unit 22 (FIG. 1) and/or another included controller, processing unit, or the like provided in the stowed vehicle 10.

In further or other embodiments, the two-way communication link between the mobile device 20 and the stowed vehicle 10, system 100, remote camera(s), and/or components or subsystems thereof may be provided, at least in part, via a wide area network 346 such as a mobile/cellular network, the internet of things, or the like. For example, the wide area network 346 may be utilized when a distance between the stowed vehicle 10 and the mobile device 20 is outside of a range of the applicable local area radio transmitters, receivers, transceivers, or the like. In such embodiments and situations, the communication control module 342 and/or control unit 22 may facilitate, request, or send appropriate communication instructions to establish the one-way and/or two-way communication link through the wide area network 346, potentially utilizing the cloud system 26. In some such embodiments and situations, the communication control module 342 and/or control unit 22 may provide a warning, alert, or the like via display(s) of the mobile device 20 that such wide area network may consume or utilize data of a cellular data plan associated with the mobile device 20, the system 100, and/or the vehicle stowed 10. Communication between the mobile device 20, the stowed vehicle 10, and/or the remote camera(s) (e.g., the wide area connection as illustrated and/or near field connections) may be facilitated by and/or established through suitable applications, mobile applications, application programming interfaces, or the like running on the mobile device 20, the control unit 22, the remote camera(s) or associated devices, and/or the cloud system 26.

Referring now to FIG. 6, a schematic diagram of an exemplary embodiment of a communication protocol is illustrated that may be utilized in conjunction with various of the systems and methods disclosed herein, in accordance with aspects of the present subject matter. For example, the communication protocol 660 includes communication protocol elements (CP elements), one or more of which may be utilized in association with operation of the system 100, the mobile device 20, the remote camera(s), the similarly configured vehicle(s) 1010, 2010, the control logic 336, the method 402, the suspicious event module 340, the communication control module 342, and/or any of the components or subsystems thereof. Generally, the CP elements of the communication protocol 660 may be implemented via a processor, controller, control unit, etc. of any such components with associated instructions stored in one or more memory devices thereof. It should be recognized that the remote camera indicated in FIG. 6 may include one or more of the remote cameras or associated devices disclosed herein, e.g., remote camera(s) 18C, 1018C; the associated vehicle(s); infrastructure device(s); the remote camera(s) 1018A, 2018A; and/or the associated similarly configured vehicle(s) 1010, 2010.

As shown, the communication protocol 660 may include communicating from the remote device and/or receiving at the stowed vehicle a supplemental alert indicating an occurrence of the suspicious event within the wide area environment of the vehicle, such as vehicle(s) 1010, 2010 (CP element 662). Additionally or alternatively, the communication protocol 660 may include communicating from the stowed vehicle 10 and/or receiving at the mobile device 20 an alert from the stowed vehicle targeted to the external device in response to a determination of a suspicious event in a vicinity of a stowed vehicle (CP element 664).

Additionally or alternatively, the communication protocol 660 may include communicating from the stowed vehicle 10 and/or receiving at the remote camera a request for supplemental monitoring of a suspicious area associated with a suspicious event in a vicinity of the stowed vehicle and within a wide area environment of the vehicle (CP element 666). In various embodiments and as shown, the request for supplemental monitoring 666 may include or a separate CP element(s) may include location information associated with stowed vehicle (CP element 668); location information associated with the suspicious area (CP element 670), identification information associated with the stowed vehicle (CP element 672), and/or identification information associated with the suspicious event (CP element 674).

In some embodiments, the CP element 666 and/or the CP element 668 may include at least one of geographical coordinates of the stowed vehicle; a common name and/or address of a location of the stowed vehicle; a parking location identification of the stowed vehicle; and/or a relative position of the stowed vehicle within a parking lot. Additionally or alternatively, the CP element 666 and/or the CP element 670 may include at least one of geographical coordinates of the suspicious area or a time associated with the suspicious event. Additionally or alternatively, the CP element 666, the CP element 668, and/or the CP element 670 may include at least one of a determined position and/or orientation of a suspicious area associated with the suspicious event relative to the stowed vehicle; a graphical representation of the relative position and orientation of the suspicious area and the detection area of the remote camera; or a graphical representation of a relative position of the suspicious area and the stowed vehicle. Additionally or alternatively, the CP element 666 and/or the CP element 672 may include at least one of a physical characteristic of the stowed vehicle; a vehicle identification of the stowed vehicle; information indicating at least one of an owner or operator of the stowed vehicle; a determined characteristic of an external environment surrounding the stowed vehicle; or information suitable to identify or interpret at least one of external auditory or visual identification signals produced to by stowed vehicle. Additionally or alternatively, the CP element 666 and/or the CP element 674 may include information indicating a type of the suspicious event.

Additionally or alternatively, the communication protocol 660 may include communicating from the stowed vehicle 10 and/or receiving at the remote camera predicted escape route information (CP element 676). CP element 676 may include at least one of an indication of a predicted escape route of at least one suspicious vehicle or individual associated with the suspicious event or an estimate of when the at least one suspicious vehicle or individual will be located on a portion of the predicted escape route within a detection area of the remote camera. Additionally or alternatively, the communication protocol 660 may include communicating from the remote camera and/or receiving at the stowed vehicle 10 an indication of a detection area of an external camera supported relative to a similarly configured vehicle (CP element 678).

Additionally or alternatively, the communication protocol 660 may include communicating from the remote camera and/or receiving at the stowed vehicle 10 (CP element 680) and/or a sperate CP element including at least one of location information associated with vehicle (CP element 682), location information associated with the suspicious area (CP element 684), identification information associated with the vehicle (CP element 685), or identification information associated with the suspicious event (CP element 686). Additionally or alternatively, the CP element 680 and/or the CP element 682 may include a geographic location of the vehicle. Additionally or alternatively, the CP element 680 and/or the CP element 684 may include modified location information associated with the suspicious area and generated at the vehicle. Additionally or alternatively, the CP element 680, the CP element 682 and/or the CP element 684 may include at least one of a graphical representation of a relative position of the suspicious area and at least one detection area of at least one external camera of the vehicle or a graphical representation of a relative position of the suspicious area and the stowed vehicle. Additionally or alternatively, the CP element 680 and/or the CP element 685 may include a qualitive value assessment generated at the vehicle and indicating a value of the remote camera for monitoring the suspicious area.

Additionally or alternatively, the communication protocol 660 may include communicating from the remote camera and/or receiving at the stowed vehicle 10 an indication of a predicted escape route generated at the vehicle of at least one suspicious vehicle or individual associated with the suspicious event (CP element 687). Additionally or alternatively, the communication protocol 660 may include communicating from the remote camera and/or receiving at the stowed vehicle 10 escape monitoring data suitable to provide a view of a predicted escape route of at least one suspicious vehicle or individual associated with the suspicious event (CP element 688).

Additionally or alternatively, the communication protocol 660 may include communicating from the remote camera and/or receiving at the stowed vehicle 10 a supplemental communication sufficient to provide a supplemental view of the suspicious area (CP element 689). The CP element 689 may include at least one of video data generated at the remote camera; a continuous video feed generated at the remote camera; orientation information of the remote camera; a detection area of the remote camera; location information associated with remote camera; location information associated with the suspicious area; identification information associated with the stowed vehicle; identification information associated with the suspicious event; an indication of the occurrence of the suspicious event; at least one of a determined position or orientation of the suspicious area associated with the suspicious event relative to the remote camera; at least one of a determined position or orientation of the suspicious area relative to the stowed vehicle; at least one of a determined position or orientation of the stowed vehicle relative to the remote camera; at least one of a determined position or orientation of a predicted escape route of at least one suspicious vehicle or individual associated with the suspicious event; an indication that that the at least one suspicious vehicle or individual is located on a portion of the predicted escape route within the detection area of the remote camera; a timestamp indicating when the at least one suspicious vehicle or individual is located on the portion of the predicted escape route within the detection area of the remote camera; geographical coordinates of the remote camera; geographical coordinates of the stowed vehicle determined at the remote camera; at least one of a common name or address of a location of the remote camera; at least one of a common name or address of a location of the stowed vehicle; a physical characteristic of the stowed vehicle; a physical characteristic of a vehicle associated with the remote camera; information indicating a type of the suspicious event determined at the remote camera; a time associated with the suspicious event; a vehicle identification associated with the remote camera; a device identification associated with the remote camera; parking location identification of the remote camera; a relative position of the remote camera within a parking lot; a determined characteristic of an external environment surrounding the stowed vehicle; a determined characteristic of an external environment surrounding the remote camera; a determined characteristic of an external environment surrounding the stowed vehicle; or a value assessment generated at the remote camera and indicating the value of the remote camera for monitoring the suspicious area; or information suitable to identify or interpret at least one of external auditory or visual identification signals produced at the remote camera.

Additionally or alternatively, the communication protocol 660 may include communicating from the stowed vehicle 10 and/or receiving at the mobile device 20 at least one of audio data or a visual data (CP element 690). In some embodiments, CP element 690 may include at least one of of a continuous audio feed, a continuous video feed, an audio recording, an image, a video recording, audio data generated at the stowed vehicle 10, visual data generated at the stowed vehicle 10, and/or visual data generated at the remote camera.

Additionally or alternatively, the communication protocol 660 may include communicating from the mobile device 20 and/or receiving at the stowed vehicle 10 data indicating audio to be played via at least one noise generator of the stowed vehicle (CP element 691). In various embodiments, the CP element 691 may include at least one of a continuous audio feed communicated from the external device or a previously recorded audio message.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

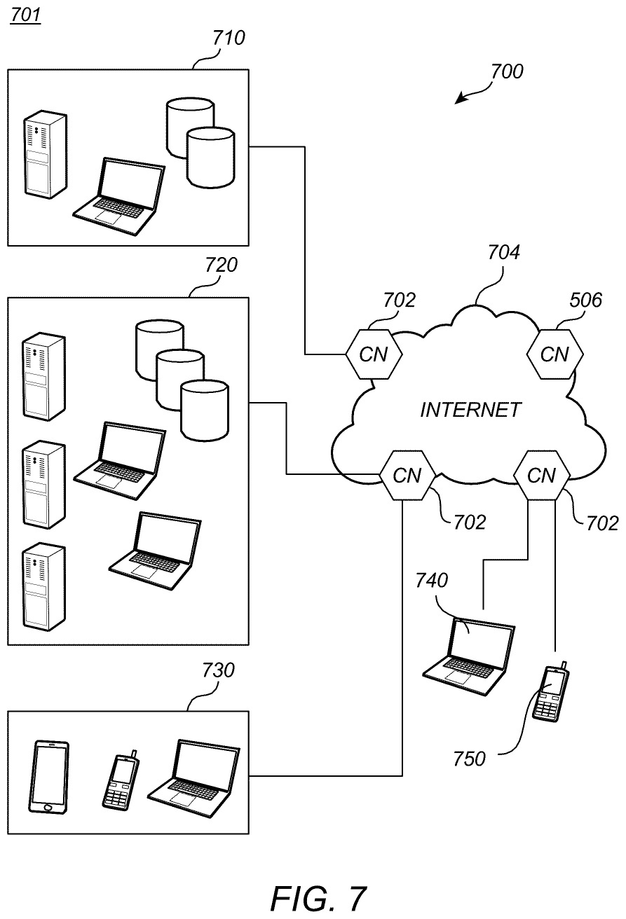

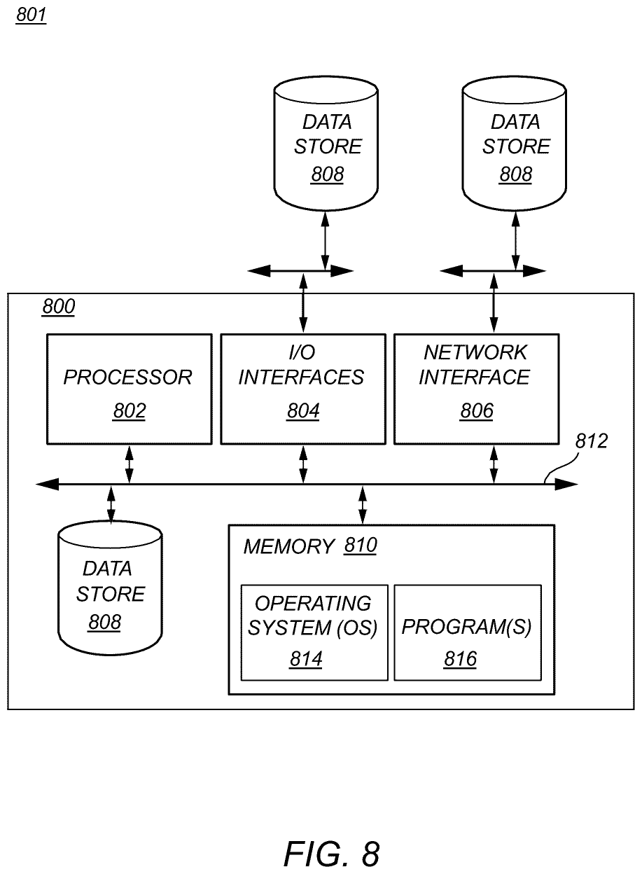

FIG. 7 is a network diagram of a cloud-based system 700 for implementing various cloud-based services of the present disclosure. The cloud-based system 700 includes one or more cloud nodes (CNs) 702 communicatively coupled to the Internet 704 or the like. The cloud nodes 702 may be implemented as a server 800 (as illustrated in FIG. 8) or the like and can be geographically diverse from one another, such as located at various data centers around the country or globe. Further, the cloud-based system 700 can include one or more central authority (CA) nodes 706, which similarly can be implemented as the server 800 and be connected to the CNs 702. For illustration purposes, the cloud-based system 700 can connect to a regional office 710, headquarters 720, various employee's homes 730, laptops/desktops 740, and mobile devices 750, each of which can be communicatively coupled to one of the CNs 702. These locations 710, 720, and 730, and devices 740 and 750 are shown for illustrative purposes, and those skilled in the art will recognize there are various access scenarios to the cloud-based system 700, all of which are contemplated herein. The devices 740 and 750 can be so-called road warriors, i.e., users off-site, on-the-road, etc. The cloud-based system 700 can be a private cloud, a public cloud, a combination of a private cloud and a public cloud (hybrid cloud), or the like.

Again, the cloud-based system 700 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 710, 720, and 730 and devices 740 and 750. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 700 is replacing the conventional deployment model. The cloud-based system 700 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 700 is illustrated herein as one example embodiment of a cloud-based system, and those of ordinary skill in the art will recognize the systems and methods described herein are not necessarily limited thereby.

FIG. 8 is a block diagram of a server 800, which may be used in the cloud-based system 700 (FIG. 7), in other systems, or stand-alone. For example, the CNs 702 (FIG. 7) and the central authority nodes 706 (FIG. 7) may be formed as one or more of the servers 800. The server 800 may be a digital computer that, in terms of hardware architecture, generally includes a processor 802, input/output (I/O) interfaces 804, a network interface 806, a data store 808, and memory 810. It should be appreciated by those of ordinary skill in the art that FIG. 8 depicts the server 800 in an oversimplified manner, and a practical embodiment may include additional components and suitably configured processing logic to support known or conventional operating features that are not described in detail herein. The components (802, 804, 806, 808, and 810) are communicatively coupled via a local interface 812. The local interface 812 may be, for example, but is not limited to, one or more buses or other wired or wireless connections, as is known in the art. The local interface 812 may have additional elements, which are omitted for simplicity, such as controllers, buffers (caches), drivers, repeaters, and receivers, among many others, to enable communications. Further, the local interface 812 may include address, control, and/or data connections to enable appropriate communications among the aforementioned components.

The processor 802 is a hardware device for executing software instructions. The processor 802 may be any custom made or commercially available processor, a central processing unit (CPU), an auxiliary processor among several processors associated with the server 800, a semiconductor-based microprocessor (in the form of a microchip or chipset), or generally any device for executing software instructions. When the server 800 is in operation, the processor 802 is configured to execute software stored within the memory 810, to communicate data to and from the memory 810, and to generally control operations of the server 800 pursuant to the software instructions. The I/O interfaces 804 may be used to receive user input from and/or for providing system output to one or more devices or components.

The network interface 806 may be used to enable the server 800 to communicate on a network, such as the Internet 704 (FIG. 7). The network interface 806 may include, for example, an Ethernet card or adapter (e.g., 10BaseT, Fast Ethernet, Gigabit Ethernet, or 10GbE) or a Wireless Local Area Network (WLAN) card or adapter (e.g., 802.11a/b/g/n/ac). The network interface 806 may include address, control, and/or data connections to enable appropriate communications on the network. A data store 808 may be used to store data. The data store 808 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 808 may incorporate electronic, magnetic, optical, and/or other types of storage media. In one example, the data store 808 may be located internal to the server 800, such as, for example, an internal hard drive connected to the local interface 812 in the server 800. Additionally, in another embodiment, the data store 808 may be located external to the server 800 such as, for example, an external hard drive connected to the I/O interfaces 804 (e.g., a SCSI or USB connection). In a further embodiment, the data store 808 may be connected to the server 800 through a network, such as, for example, a network-attached file server.

The memory 810 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 710 may incorporate electronic, magnetic, optical, and/or other types of storage media. Note that the memory 810 may have a distributed architecture, where various components are situated remotely from one another but can be accessed by the processor 802. The software in memory 810 may include one or more software programs, each of which includes an ordered listing of executable instructions for implementing logical functions. The software in the memory 810 includes a suitable operating system (O/S) 814 and one or more programs 816. The operating system 814 essentially controls the execution of other computer programs, such as the one or more programs 816, and provides scheduling, input-output control, file and data management, memory management, and communication control and related services. The one or more programs 816 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

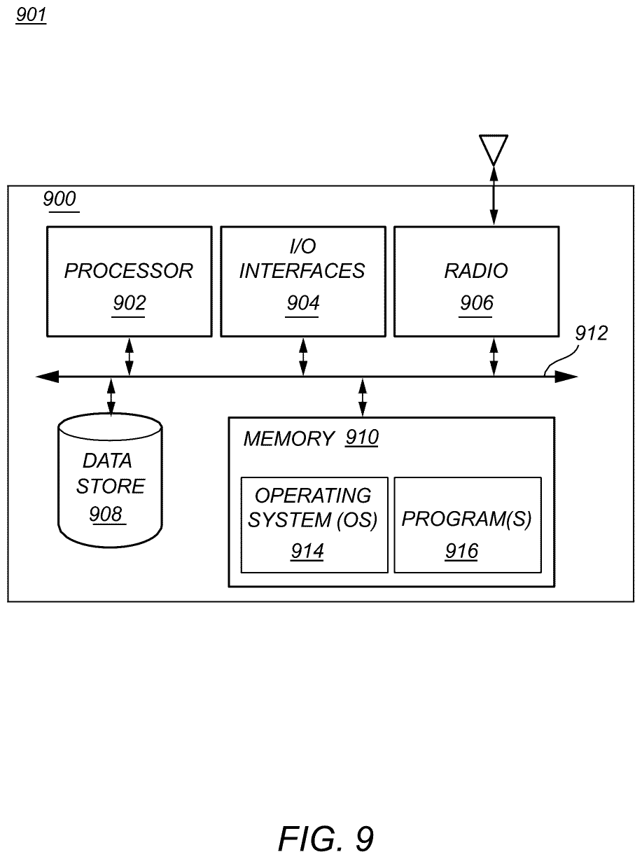

FIG. 9 is a block diagram of a user device 900, which may be used in the cloud-based system 700 (FIG. 7), as part of a network, or stand-alone. Again, the user device 900 can be a vehicle (e.g., one or more control units thereof), a smartphone, a tablet, a smartwatch, an Internet of Things (IoT) device, a laptop, a virtual reality (VR) headset, etc. The user device 900 can be a digital device that, in terms of hardware architecture, generally includes a processor 902, I/O interfaces 904, a radio 906, a data store 908, and memory 910. It should be appreciated by those of ordinary skill in the art that FIG. 9 depicts the user device 900 in an oversimplified manner, and a practical embodiment may include additional components and suitably configured processing logic to support known or conventional operating features that are not described in detail herein. The components (902, 904, 906, 908, and 910) are communicatively coupled via a local interface 912. The local interface 912 can be, for example, but is not limited to, one or more buses or other wired or wireless connections, as is known in the art. The local interface 912 can have additional elements, which are omitted for simplicity, such as controllers, buffers (caches), drivers, repeaters, and receivers, among many others, to enable communications. Further, the local interface 912 may include address, control, and/or data connections to enable appropriate communications among the aforementioned components.

The processor 902 is a hardware device for executing software instructions. The processor 902 can be any custom made or commercially available processor, a CPU, an auxiliary processor among several processors associated with the user device 900, a semiconductor-based microprocessor (in the form of a microchip or chipset), or generally any device for executing software instructions. When the user device 900 is in operation, the processor 902 is configured to execute software stored within the memory 910, to communicate data to and from the memory 910, and to generally control operations of the user device 900 pursuant to the software instructions. In an embodiment, the processor 902 may include a mobile optimized processor such as optimized for power consumption and mobile applications. The I/O interfaces 904 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 906 enables wireless communication to an external access device or network. Any number of suitable wireless data communication protocols, techniques, or methodologies can be supported by the radio 906, including any protocols for wireless communication. The data store 908 may be used to store data. The data store 908 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 808 may incorporate electronic, magnetic, optical, and/or other types of storage media.

Again, the memory 910 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 910 may incorporate electronic, magnetic, optical, and/or other types of storage media. Note that the memory 910 may have a distributed architecture, where various components are situated remotely from one another, but can be accessed by the processor 902. The software in memory 910 can include one or more software programs, each of which includes an ordered listing of executable instructions for implementing logical functions. In the example of FIG. 9, the software in the memory 910 includes a suitable operating system 914 and programs 916. The operating system 914 essentially controls the execution of other computer programs and provides scheduling, input-output control, file and data management, memory management, and communication control and related services. The programs 916 may include various applications, add-ons, etc. configured to provide end user functionality with the user device 900. For example, example programs 916 may include, but not limited to, a web browser, social networking applications, streaming media applications, games, mapping and location applications, electronic mail applications, financial applications, and the like. In a typical example, the end-user typically uses one or more of the programs 916 along with a network, such as the cloud-based system 700 (FIG. 7).

Again, embodiments of the disclosed systems and methods facilitate communication between a stowed vehicle and a remote device (e.g., mobile device) of an operator/owner of the stowed vehicle. Generally, the owner/operator may be outside of the surroundings or immediate surroundings of the stowed vehicle. The system (via, e.g., an associated suspicious event identification module and/or associated method elements) can determine an occurrence of a suspicious event in the vicinity of the stowed vehicle based on a reduced volume of external environmental data processed while the vehicle is stowed. Once the suspicious event has been identified, a suspicious area around the suspicious event may be determined relative to the stowed vehicle or its external sensors. Thereafter, a larger volume of external environmental data indicating the determined suspicious area may be monitored by the system. Sensors and/or data indicating other areas of the vicinity of the stowed vehicle may not be utilized or processed to conserve resources. For example, external sensors kept off or in standby before detection of the suspicious event may be powered, and/or data communicated from such sensors may be processed by the system after determining the suspicious event and that such sensor indicates the suspicious event or suspicious area. Thus, battery power of the system may be conserved by only monitoring the suspicious area associated with a suspicious event in detail and otherwise monitoring or processing the reduced volume of data for the occurrence of the suspicious event.

The initial determination of the suspicious event may also be based on the location of the stowed vehicle and crime data for such location, a schedule of the vehicle or the operator/owner, and/or a travel history of the same. The system may further identify a potential suspicious event utilizing the reduced volume of data and confirm the existence of the suspicious event utilizing the larger volume of data. If required, the system may process or monitor even more data or different data if the larger volume of data does not adequately represent the confirmed suspicious event or the surrounding suspicious area. Thus, the system monitors more data for a determined suspicious event and utilizes the most appropriate external sensors to monitor the suspicious event and suspicious area as circumstances change, such as movement of involved individuals, objects, vehicles, and the like.

The present disclosure also contemplates situations where the local external sensors of the stowed vehicle do not adequately represent the suspicious event and associated area. To ensure that suspicious events are recognized and associated areas determined, systems disclosed herein contemporaneously request and/or receive related information from the vehicle itself, from any surrounding devices, including vehicles, and/or from infrastructure devices that may have captured the vehicle incident. The vehicle opens a communication link with the other vehicle(s) and/or from the surrounding devices, including the vehicles and/or the infrastructure devices. Images/videos are requested with a specific timeframe (e.g., 22 seconds before and 1 minute after the vehicle incident). Various other information may also be exchanged over the bidirectional communication link (e.g., system identifiers, witness names and contact information, etc.).

The system (via, e.g., an associated communication module and/or associated method elements) may communicate an alert to the mobile device of the operator/owner of stowed vehicle. The alert may indicate the type of suspicious event and/or the position of the suspicious area relative to the stowed vehicle. The alert may also include an audio recording, a captured image, and/or a video recording of the suspicious event, the suspicious area, the vicinity surroundings of the stowed vehicle, and/or a wide area surrounding the stowed vehicle. In some embodiments, the system may receive a selection from the mobile device requesting continuous monitoring, and the system may communicate a continuous audio feed, video feed, or both of the suspicious event and/or suspicious area utilizing the sensors best situated and oriented to indicate the same. In other embodiments, the alert may already include one or more of the continuous audio feed or video feed.

The mobile device may also provide instructions to the system in response to the received alert. For example, the owner/operator may indicate via the mobile device that a prerecorded message should be produced via one or more external speakers, such as the external speaker(s) closest to external cameras best situation to capture the suspicious event or suspicious area. For example, the prerecorded message may be “Get away from the vehicle. You are being tape recorded,” “police are on their way,” or the like. Alternatively, the mobile device may communicate a continuous audio feed from a microphone(s) of the mobile device for production by external speakers of the stowed vehicle, allowing the owner/operator to communicate in real time with people in the vicinity of the stowed vehicle.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following, non-limiting Claims for all purposes.

What is claimed is:

1. A system for targeted vehicle monitoring assistance:
at least one external camera supported relative to a vehicle; and
at least one memory storing instructions that, when executed by one or more processors, cause the one or more processors to:
determine a position of a suspicious area relative to the vehicle, the suspicious area associated with a suspicious event in the vicinity of a stowed vehicle and within a wide area environment of the vehicle; and
communicate data from the at least one external camera suitable to provide a supplemental view of the suspicious area.

2. The system of claim 1, wherein the instructions executed by the one or more processors further cause the one or more processors to:
determine, based on a request for supplemental monitoring, the occurrence of the suspicious event in the vicinity of the stowed vehicle.

3. The system of claim 1, wherein the instructions executed by the one or more processors further cause the one or more processors to:
process only a first volume of data communicated from a first external camera of the at least one external camera prior to identification of the suspicious event in the vicinity of the stowed vehicle.

4. The system of claim 3, wherein the first external camera is at least one of a wide area camera or a bird's-eye-view camara.

5. The system of claim 3, wherein the instructions executed by the one or more processors further cause the one or more processors to:
determine, based on the processed first volume of data, the occurrence of the suspicious event in the vicinity of the stowed vehicle.

6. The system of claim 2, wherein the instructions executed by the one or more processors further cause the one or more processors to:
process, in response to the determination of the suspicious event, a second volume of data communicated from the at least one external camera, the second volume of data greater than the first volume of data and including the data suitable to provide the supplemental view.

7. The system of claim 1, wherein the instructions executed by the one or more processors further cause the one or more processors to qualitatively assess the value of the supplemental view for monitoring the suspicious area.

8. The system of claim 1, wherein the instructions executed by the one or more processors further cause the one or more processors to communicate data from the at least one external camera suitable to provide a view of a predicted escape route of at least one suspicious vehicle or individual associated with the suspicious event.

9. A non-transitory computer-readable medium comprising instructions stored in at least one memory and executed by one or more processors to carry out steps for communication between a vehicle with a system for targeted vehicle monitoring assistance and a stowed vehicle, the steps comprising:
receiving a request for supplemental monitoring of a suspicious area associated with a suspicious event in a vicinity of the stowed vehicle and within a wide area environment of the vehicle;
communicating an indication of a detection area of an external camera supported relative to the vehicle, the communicated indication targeted to the stowed vehicle; and
communicating supplemental monitoring data from the vehicle and targeted to the stowed vehicle, the supplemental monitoring data suitable to provide a supplemental view of the suspicious area.

10. The non-transitory computer-readable medium of claim 9, wherein the supplemental monitoring data is suitable to provide at least one of a supplemental recording or continuous video feed of the suspicious area.

11. The non-transitory computer-readable medium of claim 9, wherein the steps further comprise:
communicating a supplemental alert indicating an occurrence of the suspicious event within the wide area environment of the vehicle.

12. The non-transitory computer-readable medium of claim 9, wherein the steps further comprise communicating at least one of location information associated with vehicle, location information associated with the suspicious area, identification information associated with the vehicle, or identification information associated with the suspicious event.

13. The non-transitory computer-readable medium of claim 9, wherein the request for supplemental monitoring indicates at least one of location information associated with stowed vehicle, location information associated with the suspicious area, identification information associated with the stowed vehicle, or identification information associated with the suspicious event.

14. The non-transitory computer-readable medium of claim 9, wherein the steps further comprise communicating a qualitive value assessment generated at the vehicle and indicating a value of the remote camera for monitoring the suspicious area.

15. The non-transitory computer-readable medium of claim 9, wherein the steps further comprise:
receiving a graphical representation of a relative position of the suspicious area and the stowed vehicle.

16. The non-transitory computer-readable medium of claim 9, wherein the steps further comprise:
communicating a graphical representation of a relative position of the suspicious area and at least one detection area of at least one external camera of the vehicle.

17. The non-transitory computer-readable medium of claim 9, wherein the steps further comprise:
receiving an indication of a predicted escape route of at least one suspicious vehicle or individual associated with the suspicious event.

18. The non-transitory computer-readable medium of claim 9, wherein the steps further comprise:
communicating an indication of a predicted escape route generated at the vehicle of at least one suspicious vehicle or individual associated with the suspicious event.

19. The non-transitory computer-readable medium of claim 9, wherein the steps further comprise:
communicating escape monitoring data from the vehicle and targeted to the stowed vehicle, the escape monitoring data suitable to provide a view of a predicted escape route of at least one suspicious vehicle or individual associated with the suspicious event.

20. The non-transitory computer-readable medium of claim 9, wherein the steps further comprise:
communicating modified location information associated with the suspicious area and generated at the vehicle.
